(19) United States
(12) Patent Application Publication
(10) Pub. No.: US 2014/0258959 A1
(43) Pub. Date: Sep. 11, 2014

(54) SUPPORT TECHNIQUE

(71) Applicant: FUJITSU LIMITED, Kawasaki-shi (JP)

(72) Inventor: Hideaki KATAGIRI, FUJISAWA (JP)

(73) Assignee: FUJITSU LIMITED, Kawasaki-shi (JP)

(21) Appl. No.: 14/284,463

(22) Filed: May 22, 2014

Related U.S. Application Data
(63) Continuation of application No. PCT/JP2011/078585, filed on Dec. 9, 2011.

(51) Int. Cl. G06F 17/50

(52) U.S. Cl. CPC G06F 17/5081; G06F 2217/82
USPC 716/115

(57) ABSTRACT

A present design support method includes: arranging capacitance cells in an entire area of a cell arrangement area of a semiconductor integrated circuit , before arranging logic cells; upon detecting that a position at which a certain logic cell will be arranged is designated, calculating a total sum of capacitance for a first capacitance check area that includes the position among plural capacitance check areas that are included in the cell arrangement area, while assuming that a capacitance cell at the position is removed; calculating a total sum of necessary capacitance for the first capacitance check area, while assuming that the certain logic cell is arranged at the position and outputting information that represents a relationship between the total sum of capacitance and the total sum of necessary capacitance for the first capacitance check area.

### CROSS-REFERENCE TO RELATED APPLICATIONS

This application is a continuing application, filed under 35 U.S.C. section 111(a), of International Application PCT/JP2011/078585, filed on Dec. 9, 2011, the entire contents of which are incorporated herein by reference.

### FIELD

This technique relates to a design support technique for semiconductor integrated circuits.

### BACKGROUND

As for the design for recent Large-Scale Integrated circuits (LSI), the countermeasures against power supply noises become important due to the enhancement of the microfabrication, increase of the scale, heightening of the operational frequency and lowering of the power supply voltage. One of the countermeasures is a method for arranging a capacitance cell.

In the arrangement or disposition of the capacitance cell, after all of normal logic cells are arranged, prepared capacitance cells that have several kinds of sizes are automatically arranged in vacant areas. For example, as illustrated in FIG. 1A, after arranging logic cells in cell arrangement areas 1100 within LSI 1000 in advance, capacitance cells are arranged in the vacant areas in the cell arrangement areas 1100 as illustrated in FIG. 1B.

Furthermore, as illustrated in FIG. 1C, spare cells are arranged in the vacant areas after arranging the capacitance cells. The spare cell is a cell that is replaceable with a specific logic cell whose interconnect layer is merely different. When a simple specification change or the like occurs for the LSI that was manufactured once, this space cell is replaced with the specific logic cell. Accordingly, it becomes possible to change the specification of the LSI only by modifying the interconnect layer.

How many capacitance cells should be arranged is determined by a total sum of capacitance required for respective logic cells, which exist within a certain area. The necessary capacitance for an individual logic cell is described in a cell library, hence, it is calculated according to this data. Then, in a state that the capacitance cells are arranged in the vacant areas after arranging the logic cells , a total sum of necessary capacitance for each of plural capacitance check areas (FIG. 2) that are provided in the cell arrangement area, and a total sum of capacitance due to the capacitance cells (hereinafter, also called “actual capacitance”) are calculated, and it is confirmed whether or not a relation that “the total sum of necessary capacitance for each capacitance check area is equal to or less than the total sum of capacitance” is satisfied.

More specifically, a following processing is carried out. In other words, (1) a designer instructs the arrangement of each logic cell, and settles the arrangement positions of all logic cells. (2) By a capacitance cell generation program, automatic arrangement of the capacitance cells is performed for the vacant areas in the cell arrangement areas. (3) When the automatic arrangement of the capacitance cells are completed, the capacitance check program calculates the actual capacitance and necessary capacitance to perform capacitance check for the LSI, and then outputs its result. Here, when the result of the capacitance check represents that “the total sum of necessary capacitance is greater than the total sum of capacitance”, the designer performs modification of the arrangement of the logic cells.

As for the modification of the arrangement of the logic cells, when the capacitance check is not passed, for example, in a state as illustrated in FIG. 3A, the designer selects the logic cell 1110, and moves the logic cell 1110 from this capacitance check area outward as illustrated in FIG. 3B. After that, by the capacitance cell generation program, the automatic arrangement of the capacitance cell is performed again. Then, for example, as illustrated in FIG. 3C, the capacitance cell 1120 whose size becomes larger is arranged, and the actual capacitance increases by that capacitance.

Otherwise, the selection of the logic cell 1110 is the same, however, as illustrated in FIG. 4A, the designer instructs to move the logic cell 1110 to position 1130 within the same capacitance check area. After that, by the capacitance cell generation program, the automatic arrangement of the capacitance cells is performed again. Then, for example, as illustrated in FIG. 4B, the capacitance cell 1120 whose size becomes larger is arranged, and the actual capacitance increases by that capacitance.

Then, the capacitance check program performs the capacitance check again. Such task and processing are repeated until the capacitance check result by the capacitance check program represents that there is no problem. When such task and processing are performed, it takes a long time up to the convergence.

(4) After that, when the capacitance check result represents that there is no problem, a spare cell generation program generates the spare cell in the vacant area.

Moreover, there is a conventional method not so as to cause the lack of the capacitance in advance by introducing a method for adding an area for that necessary capacitance to the library cell. However, it is predicted that the flexibility of the design is largely reduced, when the aforementioned library cell is used.

Patent Document 1: Japanese Laid-open Patent Publication No. 2002-288253

Patent Document 2: Japanese Laid-open Patent Publication No. 11-126823

Patent Document 3: Japanese Laid-open Patent Publication No. 2005-093947

Patent Document 4: Japanese Laid-open Patent Publication No. 2007-142282

Patent Document 5: Japanese Laid-open Patent Publication No. 11-085834

Patent Document 6: Japanese Laid-open Patent Publication No. 2004-335902

In other words, there is no conventional technique for making it possible to determine whether or not the arrangement of the logic cells is suitable in view of the capacitance, before manually arranging the logic cells and the like.

### SUMMARY

A design support apparatus relating to this technique includes: (A) a memory; and (B) a processor configured to use the memory and execute a process including: (b1) arranging a capacitance cell in a vacant area in a cell arrangement area of a semiconductor integrated circuit; (b2) upon detecting that a position at which a certain logic cell will be arranged is designated, first calculating a total sum of capacitance for a first capacitance check area that includes the position among plural capacitance check areas that are included in the cell arrangement area, while assuming that a capacitance cell at the position is removed; (b3) upon detecting that the position is designated, second calculating a total sum of necessary capacitance for the first capacitance check area, while assuming that the certain logic cell is arranged at the position; and (b4) outputting information that represents a relationship between the total sum of capacitance and the total sum of necessary capacitance for the first capacitance check area.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1A is a diagram to explain an arrangement of logic cells;

FIG. 1B is a diagram to explain an arrangement of capacitance cells;

FIG. 1C is a diagram to explain an arrangement of spare cells;

FIG. 2 is a diagram to explain a capacitance check area;

FIG. 3A is a diagram to explain capacitance check;

FIG. 3B is a diagram to explain the capacitance check;

FIG. 3C is a diagram to explain the capacitance check;

FIG. 4A is a diagram to explain the capacitance check;

FIG. 4B is a diagram to explain the capacitance check;

FIG. 5A is a diagram to explain an embodiment of this technique;

FIG. 5B is a diagram to explain the embodiment of this technique;

FIG. 5C is a diagram to explain the embodiment of this technique;

FIG. 5D is a diagram to explain the embodiment of this technique;

FIG. 6A is a diagram to explain a case where a spare cell is used;

FIG. 6B is a diagram to explain the case where the spare cell is used;

FIG. 6C is a diagram to explain the case where the spare cell is used;

FIG. 7 is a diagram depicting a configuration of a design support apparatus in this embodiment;

FIG. 8 is a diagram depicting an example of a parameter setting window;

FIG. 9 is a diagram depicting a processing flow relating to the embodiment;

FIG. 10 is a diagram depicting an example of a capacitance margin map;

FIG. 11 is a diagram depicting a processing flow relating to the embodiment;

FIG. 12 is a diagram depicting a processing flow of a processing for automatically arranging capacitance cells;

FIG. 13 is a diagram depicting the processing flow of the processing for automatically arranging capacitance cells;

FIG. 14 is a diagram depicting a processing flow of a processing for generating the capacitance margin map;

FIG. 15 is a diagram depicting the processing flow of the processing for generating the capacitance margin map;

FIG. 16 is a diagram depicting an example of a management table;

FIG. 17 is a diagram depicting the processing flow of the processing for generating the capacitance margin map;

FIG. 18 is a diagram depicting the processing flow of the processing for generating the capacitance margin map;

FIG. 19 is a diagram depicting an example of the capacitance margin map;

FIG. 20 is a diagram depicting an example of the capacitance margin map;

FIG. 21 is a diagram depicting an example of the capacitance margin map;

FIG. 22 is a diagram depicting an example of the capacitance margin map;

FIG. 23 is a diagram depicting a processing flow of an update processing;

FIG. 24 is a diagram depicting an example of an internal table;

FIG. 25 is a diagram depicting the processing flow of the update processing;

FIG. 26 is a diagram depicting the processing flow of the update processing;

FIG. 27A is a diagram depicting an example of the capacitance margin map updated by the update processing;

FIG. 27B is a diagram depicting an example of the capacitance margin map updated by the update processing;

FIG. 28 is a diagram depicting the processing flow of the update processing;

FIG. 29A is a diagram depicting a first example of a display screen;

FIG. 29B is a diagram depicting a second example of a display screen;

FIG. 29C is a diagram depicting a third example of a display screen;

FIG. 30 is a diagram depicting a fourth example of a display screen;

FIG. 31 is a diagram depicting an example of the management table;

FIG. 32A is a diagram depicting a fifth example of a display screen;

FIG. 32B is a diagram depicting a sixth example of a display screen;

FIG. 32C is a diagram depicting a seventh example of a display screen; and

FIG. 33 is a diagram depicting a functional block diagram of a computer.

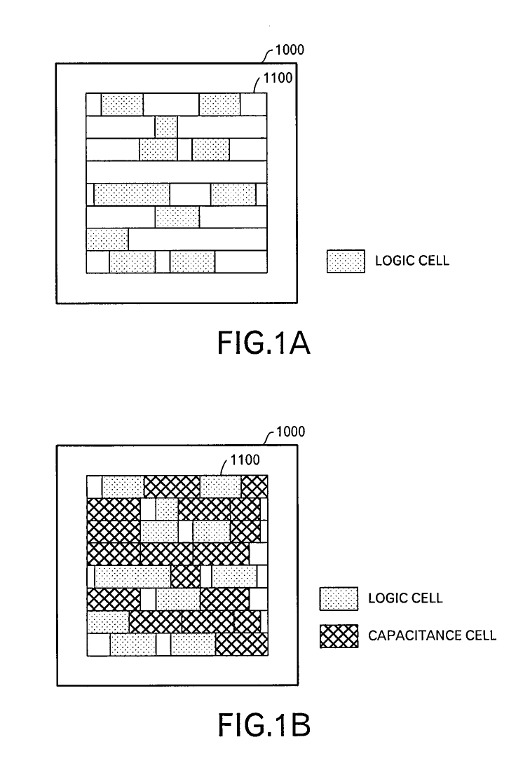

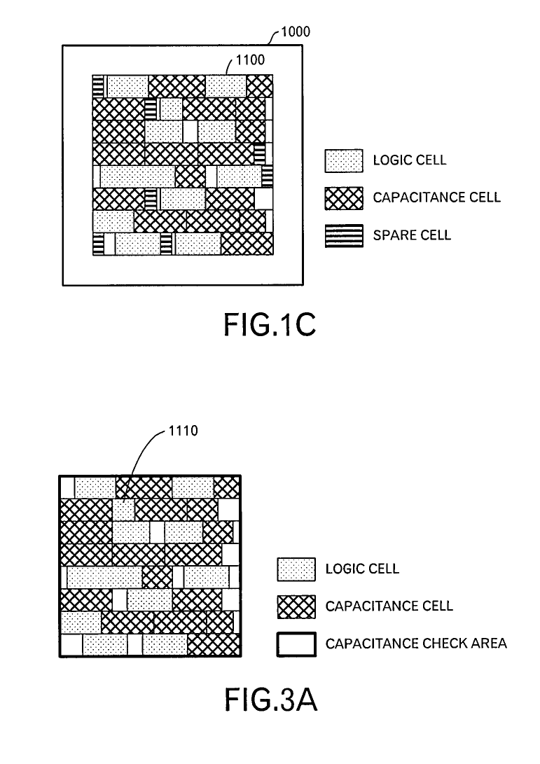

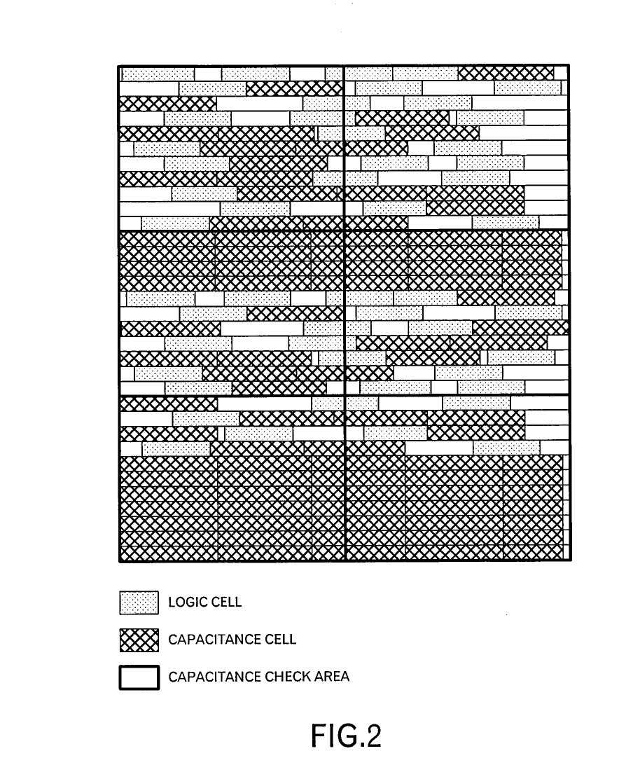

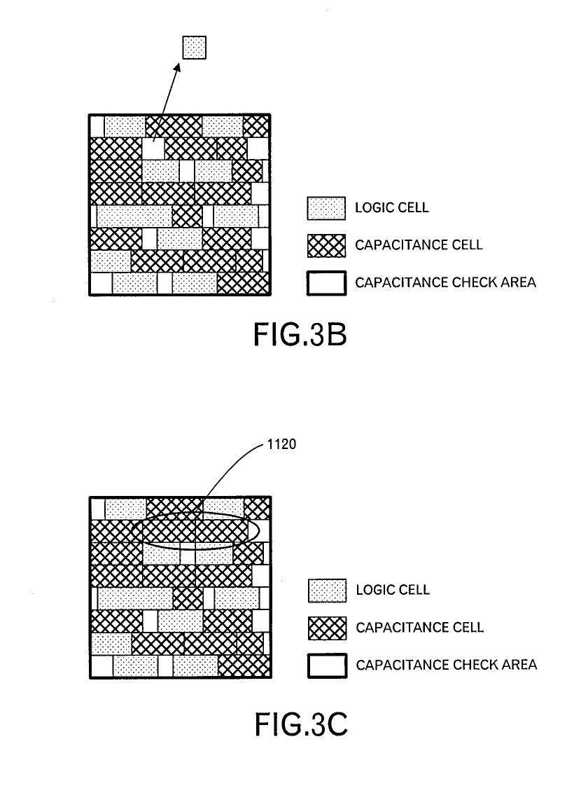

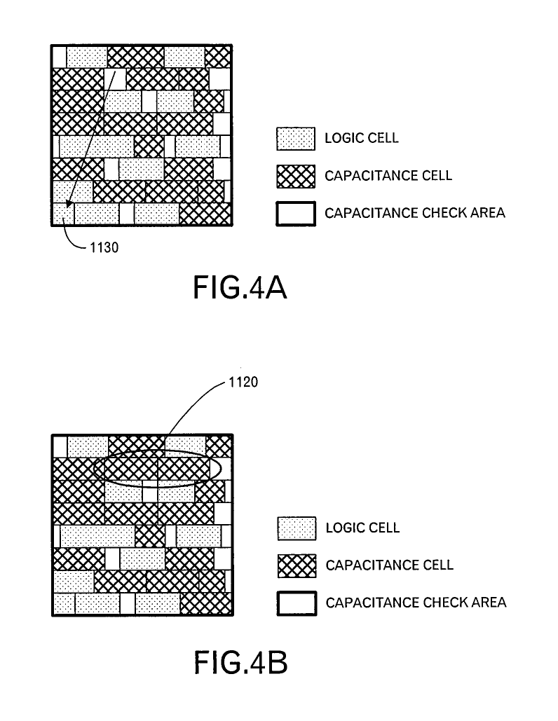

### DESCRIPTION OF EMBODIMENTS

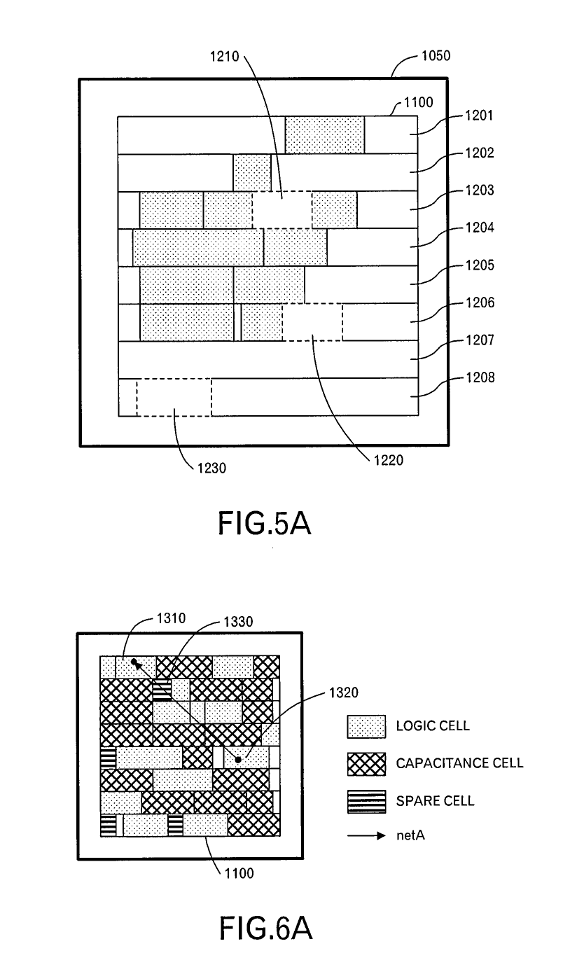

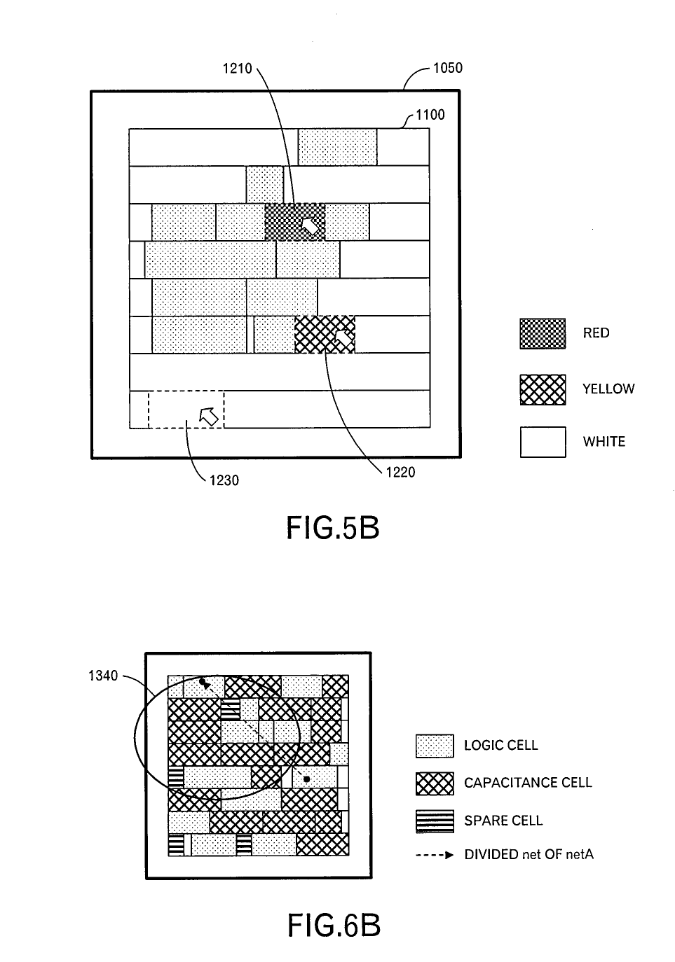

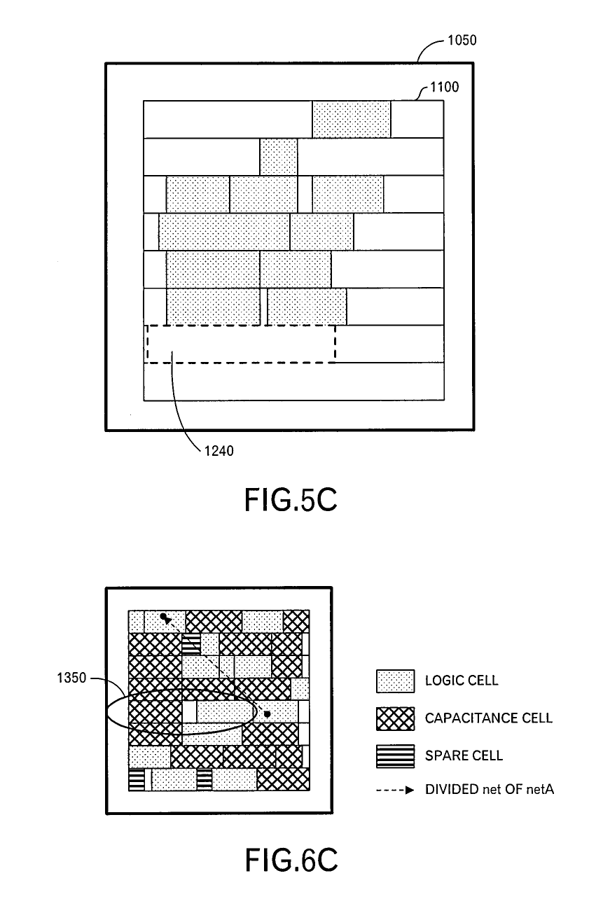

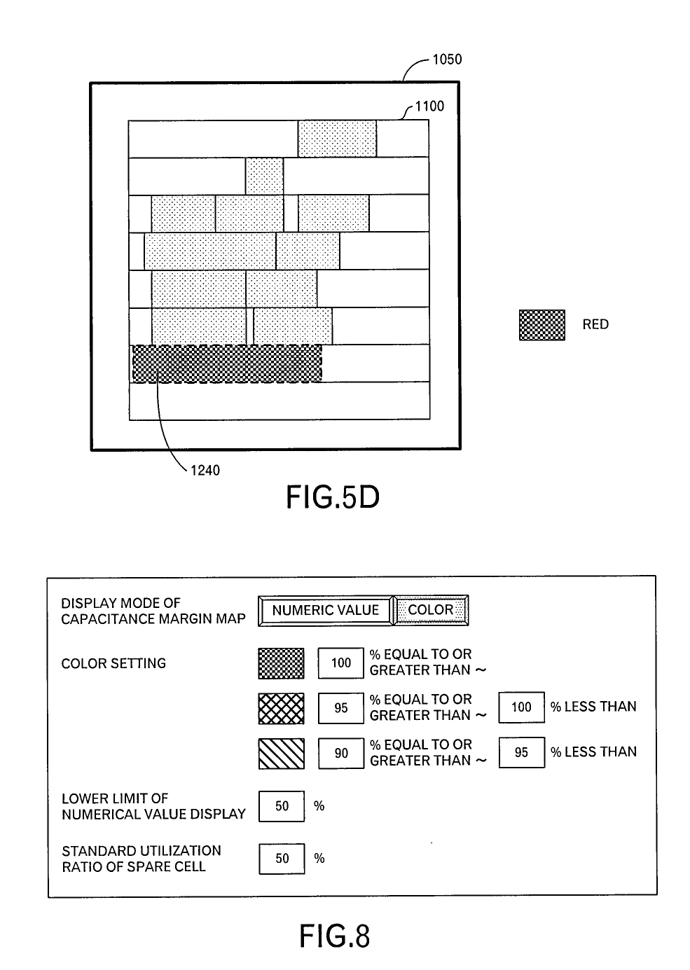

In this embodiment, firstly, the capacitance cells are arranged in cell arrangement areas of the LSI, and after that, the logic cells are arranged by using an interactive-type editor. Before the arrangement positions of the logic cells are fixed, information representing a relationship between the actual capacitance and necessary capacitance is displayed for the capacitance check area that includes projected arrangement positions. Accordingly, it becomes possible to determine whether or not arranging the logic cell at that projected arrangement position is appropriate. Specifically, as illustrated in FIG. 5A, in the cell arrangement area 1100 displayed in an arrangement task window 1050 of the interactive-type editor, after arranging capacitance cells (white) for each of sites 1201 to 1208 that are long and narrow in a horizontal direction, the designer instructs the arrangement of the logic cells, which are hatched. Furthermore, when the logic cells are arranged, it is assumed that the designer considers the projected arrangement positions 1210 to 1230 as arrangement destination candidates for the logic cells. In such a case, for example, the designer drags the logic cell to be arranged to move it to either of the projected arrangement positions 1201 to 1230. Then, in this embodiment, information representing the relationship between the actual capacitance and the necessary capacitance in case where the logic cell is preliminarily arranged at that position for each of the projected arrangement positions is displayed. For example, the relationship between the actual capacitance and the necessary capacitance is a capacitance margin that is calculated by dividing the necessary capacitance by the actual capacitance, and it is assumed that a color corresponding to the capacitance margin that is calculated at this time among plural colors determined in advance for respective ranges of the capacitance margin is displayed at the projected arrangement position. In FIG. 5B, as for the projected arrangement position 1210, when the logic cell is preliminarily arranged here, the capacitance margin exceeds, for example, 1.0 (i.e. 100%), and for example, “red” that represents that any problem will occur is displayed. Moreover, as for the projected arrangement position 1220, when the logic cell is preliminarily arranged here, the capacitance margin is equal to or greater than 0.95 (i.e. 95%) and less that 1.0 (i.e. 100%), and “yellow” that represents that no problem will occur, however, there is no enough margin is displayed. Furthermore, as for the projected arrangement position 1230, when the logic cell is preliminarily arranged here, the capacitance margin is less than 0.5 (i.e. 50%), and “white” that represents that no problem occurs is displayed. Accordingly, it becomes possible for the designer to determine whether or not the arrangement is appropriate in view of the capacitance before fixing the arrangement of the logic cell, and to also avoid the wasteful rework.

Furthermore, in this embodiment, as for a spare cell area in which the spare cell is arranged, after arranging the capacitance cell, it is assumed that the arrangement position is manually designed with the interactive-type editor. However, when the spare cell is arranged while assuming there is no necessary capacitance in the spare cell area, the necessary capacitance is caused when actually using the spare cell in the spare cell area, and as a result, there is a case where the necessary capacitance in the capacitance check area of the arrangement destination exceeds the actual capacitance.

For example, as illustrated in FIG. 6A, it is considered that logical change to net A from the logic cell 1320 to the logic cell 1310 in the cell arrangement area 1100 is made to divide the net by inserting a buffer. In such a case, because the spare cell 1330 has been arranged so as to be adjacent to the logic cell 1310, it is considered that this spare cell 1330 is used. However, when this spare cell 1330 is used as the logic cell, the necessary capacitance increases by that necessary capacitance of the logic cell. When the spare cell 1330 is arranged without considering the necessary capacitance of the spare cell 1330, a phenomenon that the necessary capacitance exceeds the actual capacitance occurs, for example, in the area 1340 as illustrated in FIG. 6B. Therefore, as illustrated in FIG. 6C, in the area 1350, further change such as change from the spare cell to the capacitance cell might have to be made sequentially.

In this embodiment, the necessary capacitance is defined also for the spare cell area in which the spare cell is arranged, and similarly to the logic cell, before fixing the arrangement destination, the information representing the relationship between the actual capacitance and the necessary capacitance in case where the spare cell area is arranged is preliminarily arranged at the projected arrangement position is displayed. For example, as illustrated in FIG. 5C, when the spare cell area is preliminarily arranged at the projected arrangement position 1240, the capacitance margin exceeds 1.0 (i.e. 100%) as illustrated in FIG. 5D, and “red” that represents that any problem occurs is displayed. Because the entire spare cell area does not become the logic cells, the total sum of necessary capacitance in the capacitance check area is calculated by multiplying a standard ratio (also called “standard utilization ratio of the spare cell”) that the spare cell area is used as the logic cells.

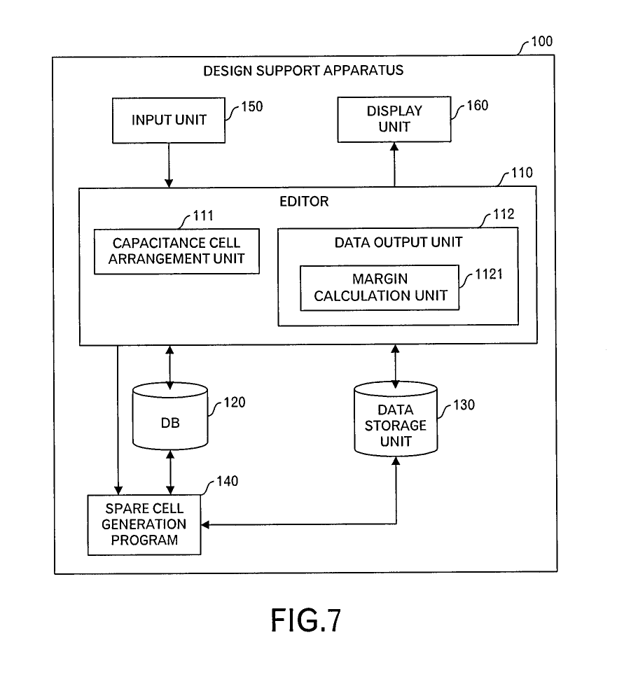

A configuration to realize the aforementioned contents will be explained by using FIGS. 7 to 31. Firstly, a configuration of a design support apparatus 100 relating to this embodiment will be explained by using FIG. 7. The design support apparatus 100 relating to this embodiment has an interactive-type editor 110, a database (DB) 120, a data storage unit 130, a spare cell generation program 140, an input unit 150 such as a mouse and/or keyboard, and a display unit 160 such as a display.

The editor 110 has a capacitance cell arrangement unit 111 and a data output unit 112. The data output unit 112 has a margin calculation unit 1121. As described below, the capacitance cell arrangement unit 111 firstly performs a processing to arrange the capacitance cells in vacant areas of the cell arrangement area. In response to a designation input from the designer from the input unit 150, the data output unit 112 generates information that is an estimation of the arrangement of the logic cell and the like and outputs the information to the display unit 160. The margin calculation unit 1121 calculates the capacitance margin as the information representing the relationship between the necessary capacitance and the actual capacitance.

The DB 120 stores logical connection information, instance information, interconnection rule information and the like in addition to the arrangement information of cells. Moreover, the data storage unit 130 stores cell library information (including data of necessary capacitance of logic cells), parameter information, spare cell information used by the spare cell generation program 140 and spacer cell information. The parameter information includes arrangement parameters, arrangement rotation code, arrangement spaces, necessary capacitance of the spare cell area, capacitance cell information (including data of the actual capacitance of the capacitance cell for each size), capacitance preset value, capacitance check parameter, parameters for display, which were inputted from a user and the like. The data storage unit 130 may store data during the processing of the editor 110.

Next, processing contents of the design support apparatus 100 will be explained by using FIGS. 8 to 31. The editor 110 causes the display unit 160 to display a parameter setting window as illustrated in FIG. 8 to prompt the user to perform the setting. In an example of FIG. 8, a setting for a display mode of a capacitance margin map, a correspondence between a color and a range of the capacitance margin in case where a color display mode is set, a lower limit of numerical value display and a standard utilization ratio of the spare cell are set . As for the display mode of the capacitance margin map, a numerical value display mode, a color display mode or both of them can be selected. As for the correspondence between the color in the color display mode and a range of the capacitance margin, an example in which 4 colors including the white are used is illustrated, however, two kinds of colors may be used, otherwise, more colors maybe used. The editor 110 accepts, as parameters for the capacitance margin map, parameters set in such a parameter setting window, and stores the parameters into the data storage unit 130, for example.

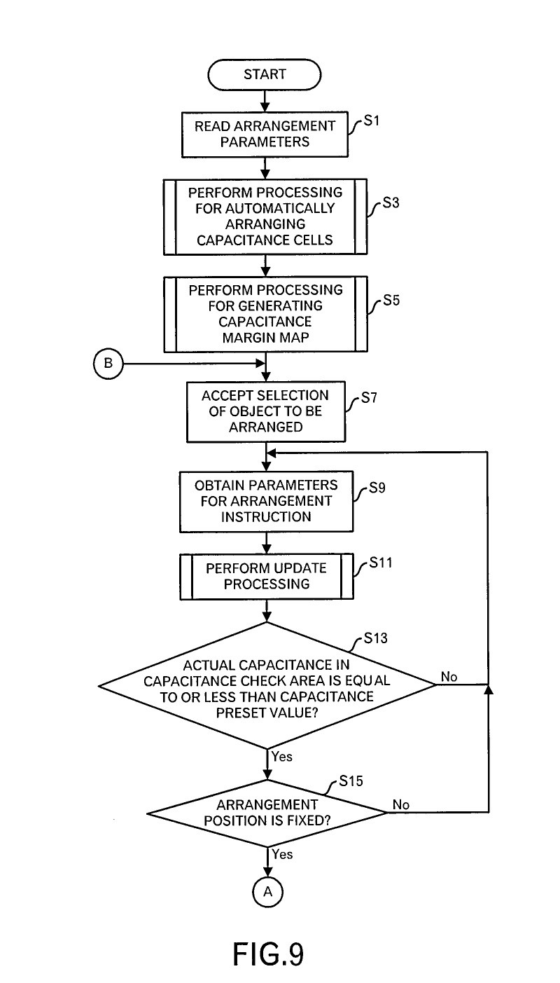

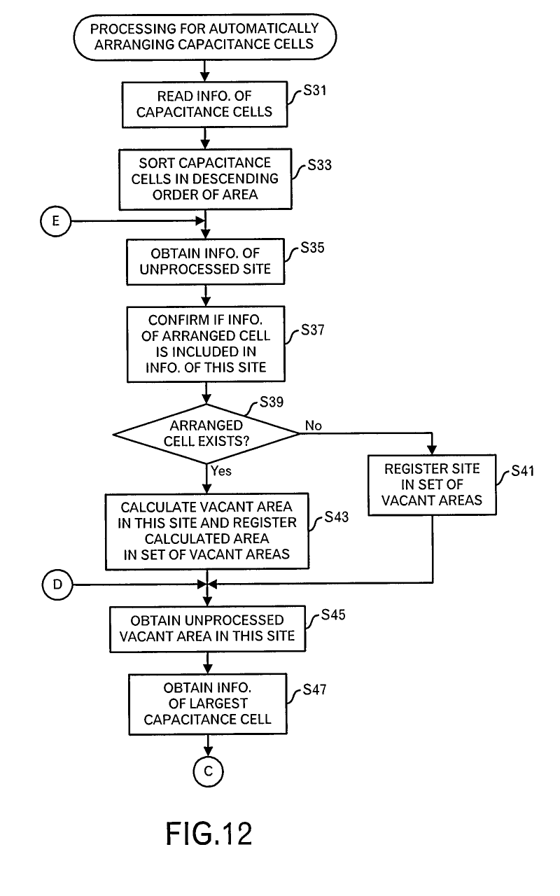

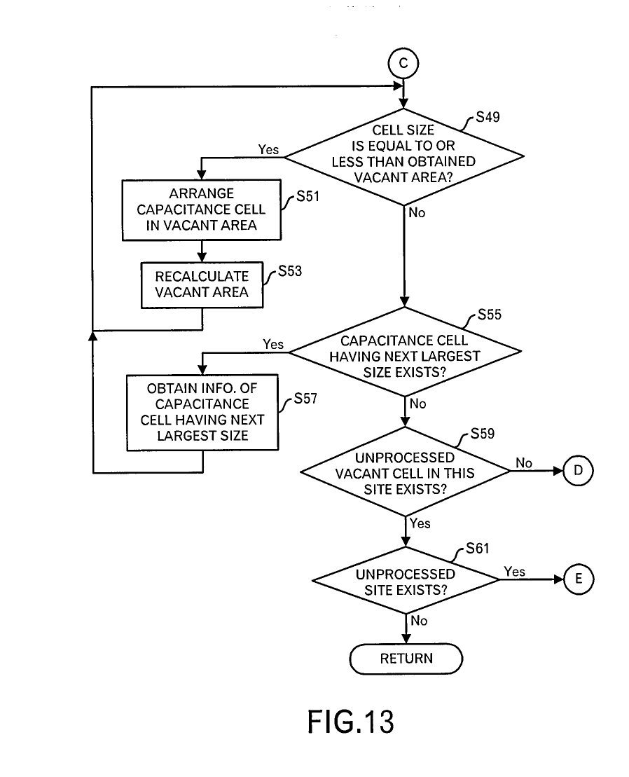

Then, the designer designates a specific LSI as a target of the physical design for the editor 110 through the input unit 150, for example, and performs a following processing in case where the processing start is instructed. In other words, the editor 110 reads out parameter information used in the following processing and stored in the data storage unit 130 (step S1 in FIG. 9), and causes the capacitance cell arrangement unit 111 to perform a processing for automatically arranging capacitance cells (step S3). The processing for automatically arranging the capacitance cells will be explained later by using FIGS. 12 and 13. This processing is a processing for arranging the capacitance cells in the vacant areas of the cell arrangement area as many as possible.

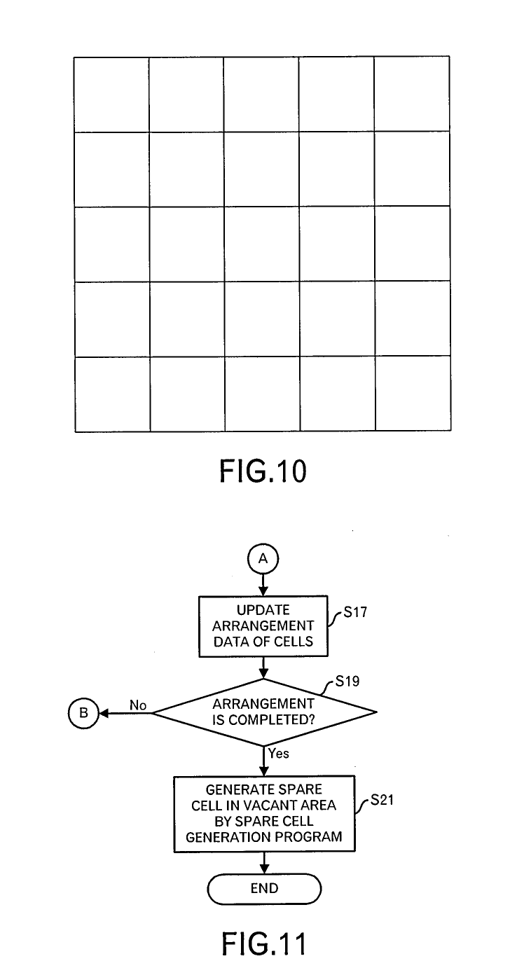

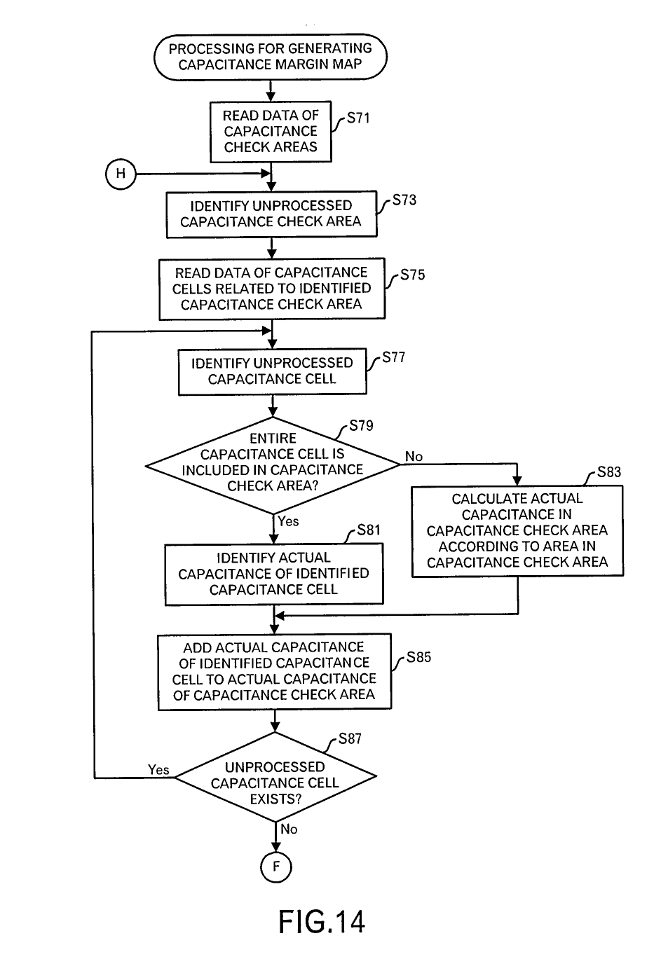

Next, the data output unit 112 or the like of the editor 110 performs a processing for generating the capacitance margin map (step S5). The processing for generating the capacitance margin map will be explained later by using FIGS. 14 to 22. This processing is a processing to generate the initial capacitance margin map and output this map to the display unit 160. The capacitance margin map is a map that represents the margin by the numerical values, colors or both of them for each of plural capacitance check areas included in the cell arrangement area as illustrated in FIG. 10. However, in a state where the capacitance cells are merely arranged, the capacitance margin is “0”, because the necessary capacitance is “0”, and in an example of FIG. 10, coloring is not made. When the numerical value is less than the lower limit of the display, the numerical value is not displayed.

Then, the designer selects the logic cell or spare cell area as a new object to be arranged, or selects the logic cell or spare cell area, which has already been arranged, as an object to be arranged, when the processing advanced. Then, the designer drags the object to be arranged, for example, and moves it to a position at which the object is to be arranged, in other words, the projected arrangement position. At this time, referring to the capacitance margin map, a place that is considered as being appropriate in view of the capacitance is selected as the projected arrangement position.

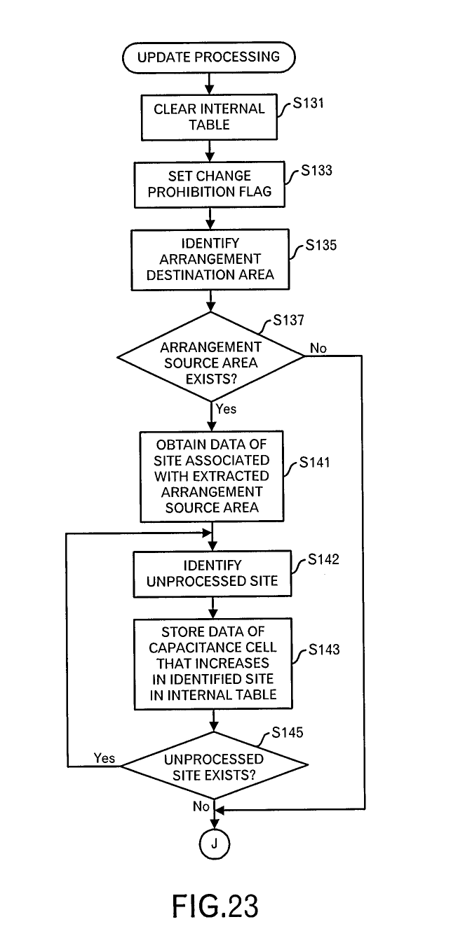

The editor 110 accepts a selection input of an object to be arranged, by the designer, from the input unit 150 (step S7), and obtains arrangement instruction parameters such as the projected arrangement positions (step S9). Then, the editor 110 performs an update processing of the capacitance margin map and the like according to an operation to move the object to be arranged to the projected arrangement position (step S11). This update processing will be explained later by using FIGS. 23 to 31. This update processing is not only a processing to perform display as illustrated in FIGS. 5B to 5D, but also to update the display of the capacitance margin map illustrated in FIG. 10.

Then, the editor 110 determines whether or not the actual capacitance in the capacitance check area including a present projected arrangement position is equal to or less than a capacitance preset value stored in the data storage unit 130 when preliminarily arranging the object to the present projected arrangement position (step S13). Here, when the actual capacitance in the capacitance check area including the present projected arrangement position is equal to or less than the capacitance preset value, it is possible to fix the arrangement to the present projected arrangement position. In other words, the editor 110 can drop the object to be arranged. On the other hand, when the actual capacitance in the capacitance check area exceeds the capacitance preset value, it is impossible to fix the arrangement to the present projected arrangement position. In other words, the editor 110 cannot drop the object to be arranged. Because it is impossible to fix the arrangement, the processing returns to the step S9, and the designer drags the object to be arranged to another projected arrangement position. On the other hand, when it is possible to fix the arrangement, the designer can drop the object to be arranged. Therefore, the editor 110 determines whether or not the designer dropped the object to be arranged and fixed the arrangement (step S15). Here, when the designer continues the drag to other projected arrangement positions, the fix of the arrangement is not instructed. Therefore, the processing returns to the step S9.

When the designer dropped the object to be arranged and fixed the arrangement, the processing shifts to a processing in FIG. 11 through terminal A.

Then, the editor 110 updates the arrangement information of cells and the like in the DB 120 according to the arrangement settlement of the object to be arranged (step S17). At this time, data of the internal table that is generated in the update processing is used for this update. Moreover, the data output unit 112 updates a management table, which will be explained later, according to the arrangement information of the object to be arranged, whose arrangement was fixed this time, and data of the internal table.

Then, the editor 110 determines whether or not the arrangement completion is instructed through the input unit 150 by the designer (step S19). When the arrangement completion is not instructed, the processing returns to the step S7 in FIG. 9 through terminal B. On the other hand, when the arrangement instruction is instructed, the editor 110 causes the spare cell generation program 140 to be executed. In other words, similarly to the conventional art, the spare cell generation program 140 performs a processing to generate the spare cell in the vacant area such as the spare cell area by using parameters stored in the data storage unit 130 and the like to update the DB 120 (step S21). This processing is similar to the conventional art, therefore, detailed explanation is omitted.

By performing the aforementioned processing, the designer can arrange the logic cells and the spare cell area to be arranged while confirming appropriate positions in view of the capacitance. In other words, without repeating a processing sequence including the arrangement of the logic cell, the arrangement of the capacitance cell, and the capacitance check several times as performed in the conventional art, it becomes possible to perform the physical design of the LSI efficiently.

Next, the processing for automatically arranging the capacitance cell will be explained by using FIGS. 12 and 13. Firstly, the capacitance cell arrangement unit 111 reads out the capacitance cell information from the data storage unit 130 (FIG. 12: step S31). Then, the capacitance cell arrangement unit 111 sorts the capacitance cells in descending order of the areas of the capacitance cells, by using the areas of the capacitance cells which are included in the capacitance cell information (step S33). Furthermore, the capacitance cell arrangement unit 111 obtains information of unprocessed site, which is an arrangement reference of the capacitance cells, for example from the DB 120 (step S35). Then, the capacitance cell arrangement unit 111 determines whether or not the information of the cells, which have already been arranged, exists in the obtained information of the site (step S37). When any cell has already been arranged due to any reason, the capacitance cell is arranged while considering the arrangement of the cells.

When any already arranged cell exists in the site to be processed (step S39: Yes route), the capacitance cell arrangement unit 111 calculates a vacant area within the site, and registers the vacant area into a set of the vacant areas (step S43). Then, the processing shifts to step S45. For example, when the already arranged cell is arranged in the center of the site, the site may be divided into two vacant areas . On the other hand, when the already arranged cell does not exist within the site to be processed, the capacitance cell arrangement unit 111 registers the entire site into the set of the vacant areas (step S41). Then, the processing shifts to the step S45.

After that, the capacitance cell arrangement unit 111 obtains one unprocessed vacant area within the site from the set of the vacant areas (step S45). Moreover, the capacitance cell arrangement unit 111 obtains information of the largest capacitance cell from the result of the sorting at the step S33 (step S47). Then, the processing shifts to a processing of FIG. 13 through terminal C.

Shifting to the explanation of the processing in FIG. 13, the capacitance cell arrangement unit 111 determines whether or not the cell size of the capacitance cell to be processed is equal to or less than the obtained vacant area (step S49). When the cell size of the capacitance cell to be processed is equal to or less than the obtained vacant area, the capacitance cell arrangement unit 111 performs a processing to arrange the capacitance cell in the vacant area (step S51). In other words, information of the capacitance cell to be arranged and the arrangement position is registered in the DB 120. Then, the capacitance cell arrangement unit 111 recalculates the vacant area (step S53). After that, the processing returns to the step S49. Thus, the capacitance cell having a size as large as possible is put into the vacant area.

On the other hand, when the cell size of the capacitance cell to be processed exceeds the obtained vacant area, the capacitance cell arrangement unit 111 determines whether or not the capacitance cell that has a next size in the sorting result of the step S33 exists (step S55). When there is a capacitance cell that has the next size, the capacitance cell arrangement unit 111 obtains information of the capacitance cell that has the next largest size (step S57). Then, the processing returns to the step S49. On the other hand, when there is no capacitance cell that has the next size, the capacitance cell arrangement unit 111 determines whether or not all of the vacant areas of the site to be processed have been processed (step S59). When there is an unprocessed vacant area, the processing returns to the step S45 in FIG. 12 through terminal D. On the other hand, when all of the vacant areas in the site to be processed were processed, the capacitance cell arrangement unit 111 determines whether or not there is an unprocessed site (step S61). When there is an unprocessed site, the processing returns to the step S35 in FIG. 12 through terminal E.

By carrying out the aforementioned processing, it is possible to cover the vacant areas in the cell arrangement areas with the capacitance cells as broad as possible . Thus, it is possible to initially settle the actual capacitance that is a denominator of the capacitance margin. In other words, at the timing when starting arranging the logic cells and the like, it becomes possible to correctly calculate the capacitance margin.

Next, the processing for generating the capacitance margin map will be explained by using FIGS. 14 to 22. The data output unit 112 reads data of the capacitance check area from the data storage unit 130, for example (FIG. 14: step S71). Then, the data output unit 112 identifies one unprocessed capacitance check area (step S73). Moreover, the data output unit 112 reads out data of the capacitance cells relating to the capacitance check area from the DB 120 (step S75). The data output unit 112 reads data of the capacitance cells whose at least part is included in the capacitance check area to be processed. Then, the margin calculation unit 1121 identifies one unprocessed capacitance cell among the read capacitance cells (step S77). Here, the margin calculation unit 1121 determines whether or not the whole of the identified capacitance cell is included in the identified capacitance check area (step S79). When the whole of the identified capacitance cell is included in the identified capacitance check area, the margin calculation unit 1121 identifies the actual capacitance of this capacitance cell as capacitance to be added (step S81). Then, the processing shifts to step S85.

On the other hand, when a portion of the identified capacitance cell is included in the identified capacitance check area, the margin calculation unit 1121 calculates the area, which is included in this capacitance check area, within this capacitance cell, and calculates “the actual capacitance”*“the calculated area”/“the entire area of the capacitance cell”, in other words proportionally divides the actual capacitance with the calculated area to identify the calculated capacitance for this capacitance check area as the capacitance to be added (step S83). Then, the processing shifts to the step S85.

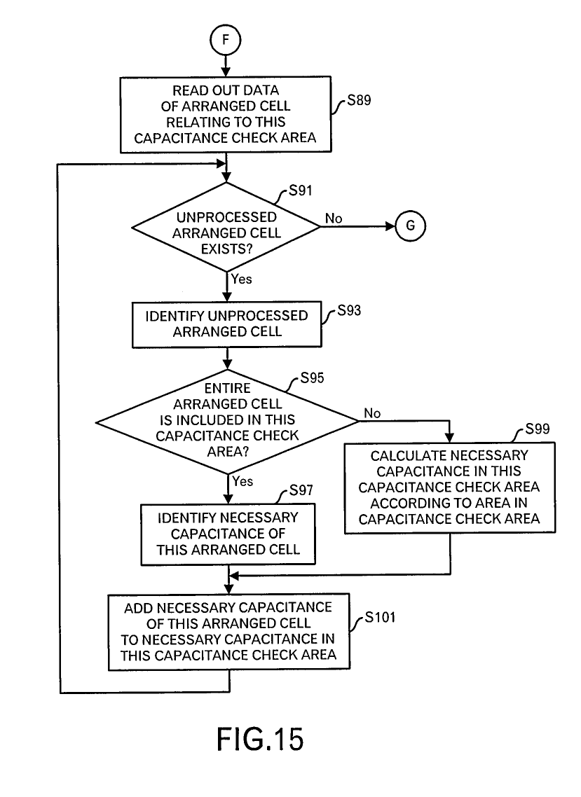

After that, the margin calculation unit 1121 adds the actual capacitance to be added for the identified capacitance cell to the total sum of actual capacitance in the identified capacitance check area, and stores the calculated value into a storage device such as a main memory (step S85). Then, the margin calculation unit 1121 determines whether or not there is an unprocessed capacitance cell among the capacitance cells identified at the step S75 (step S87). When there is an unprocessed capacitance cell, the processing returns to the step S77. On the other hand, when there is no unprocessed capacitance cell, the processing shifts to the processing in FIG. 15 through the terminal F.

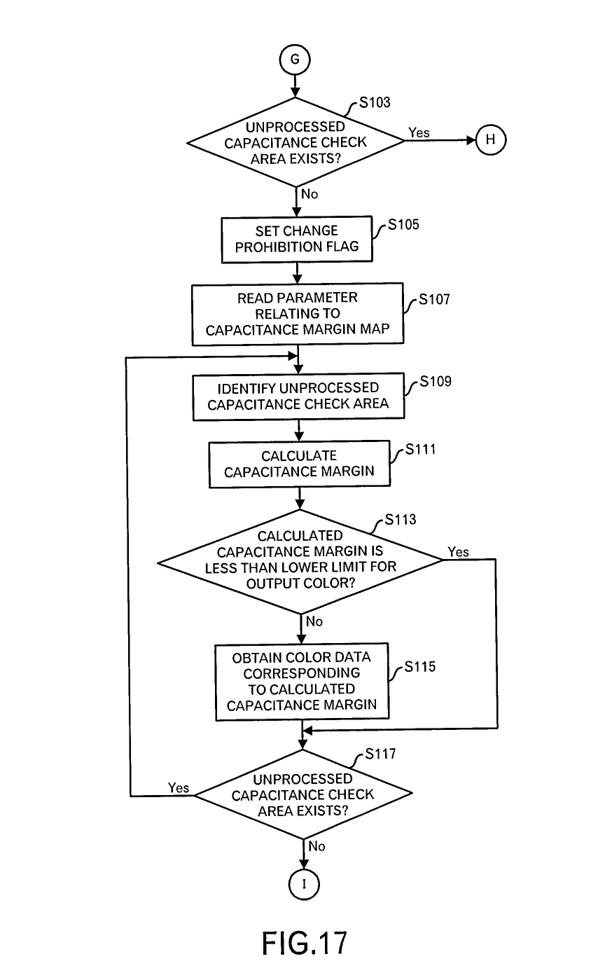

Next, the data output unit 112 reads out data of the arranged cells, which are other than the capacitance cell and relate to the identified capacitance check area, from the DB 120 (FIG. 15: step S89). When any cells were arranged before manually arranging the logic cell, data of those cells is read out . Then, the margin calculation unit 1121 determines whether or not there is an unprocessed arranged cell among the arranged cells whose data was read at the step S89 (step S91). When there is no unprocessed arranged cell, the processing shifts to a processing in FIG. 17 through terminal G. On the other hand, when there is an unprocessed arranged cell, the margin calculation unit 1121 identifies one unprocessed arranged cell among the arranged cells whose data was read out (step S93). Here, the margin calculation unit 1121 determines whether or not the whole of the identified arranged cell is included in the identified capacitance check area (step S95). When the whole of the identified arranged cell is included in the identified capacitance check area, the margin calculation unit 1121 identifies the necessary capacitance of this arranged cell as the capacitance to be added (step S97). Then, the processing shifts to step S101.

On the other hand, when a portion of the identified arranged cell is included in the identified capacitance check area, the margin calculation unit 1121 calculates the area included in this capacitance check area within this arranged cell, and calculates “the necessary capacitance”*“the calculated area”/“the entire area of the arranged cell”, in other words proportionally divides the necessary capacitance with the area to identify the capacitance for this capacitance check area as the capacitance to be added (step S99). Then, the processing shifts to the step S101.

After that, the margin calculation unit 1121 adds the necessary capacitance to be added for the identified arranged cell to the necessary capacitance for the identified capacitance check area, and stores the calculated value into the storage device such as a main memory (step S101). Then, the processing returns to the step S91.

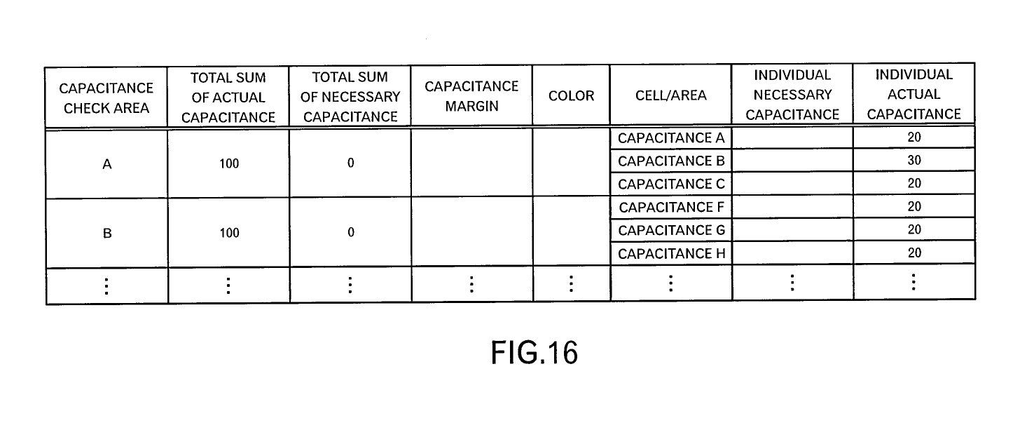

For example, the management table as illustrated in FIG. 16 is held in the storage device such as the main memory or the data storage unit 130, for example. In an example of FIG. 16, for each capacitance check area, the total sum of actual capacitance, total sum of necessary capacitance, the capacitance margin, a color in the capacitance margin map, an identifier of the cell or area, which relates to this capacitance check area, individual necessary capacitance or individual actual capacitance of that cell or area are registered. The identifier of the cell or area, which relates to the capacitance check area, and the individual necessary capacitance or individual actual capacitance of that cell or area are registered at the step S75 and step S89. However, those data may not be registered in the management table.

Next, shifting to the explanation of the processing in FIG. 17, the margin calculation unit 1121 determines whether or not there is an unprocessed capacitance check area (step S103). When there is an unprocessed capacitance check area, the processing returns to the step S73 through terminal H. On the other hand, when there is no unprocessed capacitance check area, the total sum of necessary capacitance and the total sum of actual capacitance have been calculated for each capacitance check area.

Then, the margin calculation unit 1121 sets a change prohibition flag in order to prohibit the change of the parameters associated with the capacitance margin map (step S105). Then, the margin calculation unit 1121 reads out the parameters associated with the capacitance margin map from the data storage unit 130 (step S107). For example, inputted data in association with FIG. 8 is read.

After that, the margin calculation unit 1121 identifies one unprocessed capacitance check area (step S109), calculates the capacitance margin for that capacitance check area by dividing the necessary capacitance by the actual capacitance, and stores the calculated value into the management table, for example (step S111), As for the capacitance margin, “0” represents that there is a large margin and “1” represents that there is no margin.

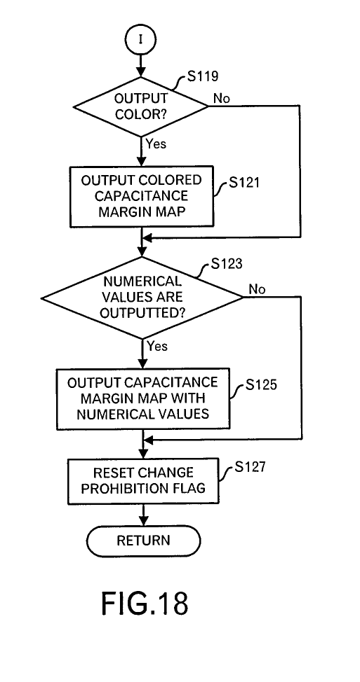

Then, the margin calculation unit 1121 determines whether or not the calculated capacitance margin is less than the lower limit value of the color output, which is included in the parameters associated with the capacitance margin map (step S113). When the capacitance margin is less than the lower limit value of the color output, the processing shifts to the step S117. On the other hand, when the capacitance margin is equal to or greater than the lower limit value of the color output, the margin calculation unit 1121 obtains color data corresponding to the calculated capacitance margin from the parameters associated with the capacitance margin map, and registers the color data into the management table, for example (step S115). After that, the margin calculation unit 1121 determines whether or not there is an unprocessed capacitance check area (step S117). When there is an unprocessed capacitance check area, the processing returns to the step S109. On the other hand, when there is no unprocessed capacitance check area, the processing shifts to a processing in FIG. 18 through terminal I.

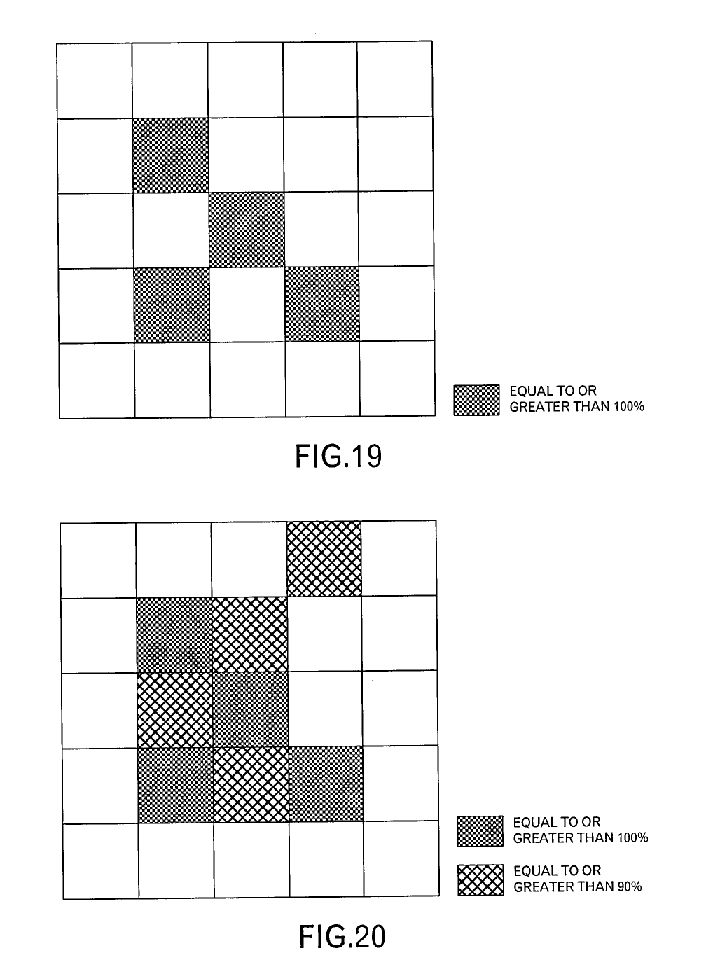

Shifting to the explanation of the processing in FIG. 18, the data output unit 112 determines whether or not the color output is instructed as the parameters associated with the capacitance margin map (step S119). When the color output is not instructed, the processing shifts to step S123. When the color output is instructed, the data output unit 112 generates the capacitance margin map with the color identified for each capacitance check area, and outputs the map to the display unit 160 (step S121). Initially, because the necessary capacitance is often almost equal to “0”, the capacitance margin map without any colors is generated as illustrated in FIG. 10. For example, when the lower limit value of the color output is “1” (=100%), the capacitance margin map as illustrated in FIG. 19 is generated. Moreover, when the lower limit value of the color output is equal to or greater than 0.9 (=90%), and the color is separately used with a color for the margin that is equal to or greater than 1.0, the capacitance margin map is generated as illustrated in FIG. 20.

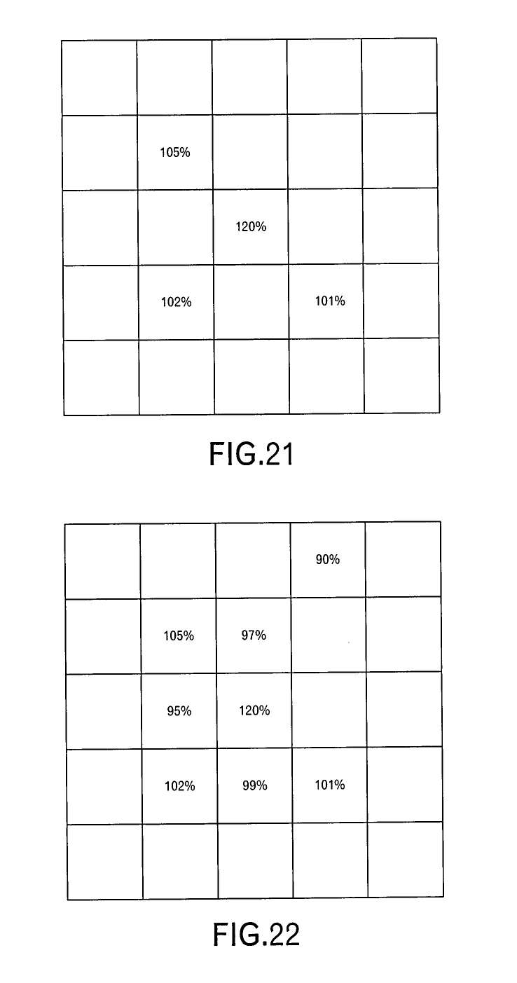

Moreover, the data output unit 112 determines whether or not the numerical value output is instructed as the parameters associated with the capacitance margin map (step S123). When the numerical value output is not instructed, the processing shifts to step S127. On the other hand, when the numerical value output is instructed, the data output unit 112 generates the capacitance margin map with the capacitance margins, which are represented by the numerical values for each capacitance check area, and output the map to the display unit 160 (step S125). For example, when the lower limit value of the output is “1” (=100%) like in FIG. 19, the capacitance margin map as illustrated in FIG. 21 is outputted. Similarly, when the lower limit value of the output is “0.9” (=90%) like in FIG. 20, the capacitance margin map as illustrated in FIG. 22 is outputted.

After that, the data output unit 112 resets the change prohibition flag (step S127). Then, the processing returns to a calling-source processing.

By performing the aforementioned processing, it is possible to output the initial capacitance margin map, and it is also possible for the designer who will arrange the logic cells and the like to roughly grasp if there is no problem in view of the capacitance when the logic cell and the like are arranged in these parts. The capacitance margin map is displayed, for example, next to the arrangement task window. However, the capacitance margin map maybe displayed in a separate window.

Next, the update processing will be explained by using FIGS. 23 to 31. The data output unit 112 clears the internal table, which temporarily stores the update contents (step S131). Then, the data output unit 112 sets the change prohibition flag in order to prohibit the change of the parameters associated with the capacitance margin map (step S133). Moreover, the data output unit 112 identifies an arrangement destination area, which is a capacitance check area including the projected arrangement position of the object to be arranged (step S135).

Furthermore, the data output unit 112 determines whether or not the arranged position of the object to be arranged has already been registered in the DB 120, in other words, there is an arrangement source area that is the capacitance check area of the arrangement source, which includes the arranged position (step S137). When an instruction to move the object to be arranged is inputted, the arrangement source area including the arranged position before moving is identified. Because there is a case where the object to be arranged is arranged over two or more capacitance check area, plural arrangement source areas may be identified. When there is no arrangement source area, in other words, when it is newly instructed to arrange the object to be arranged, the processing shifts to a processing of FIG. 25 through terminal J.

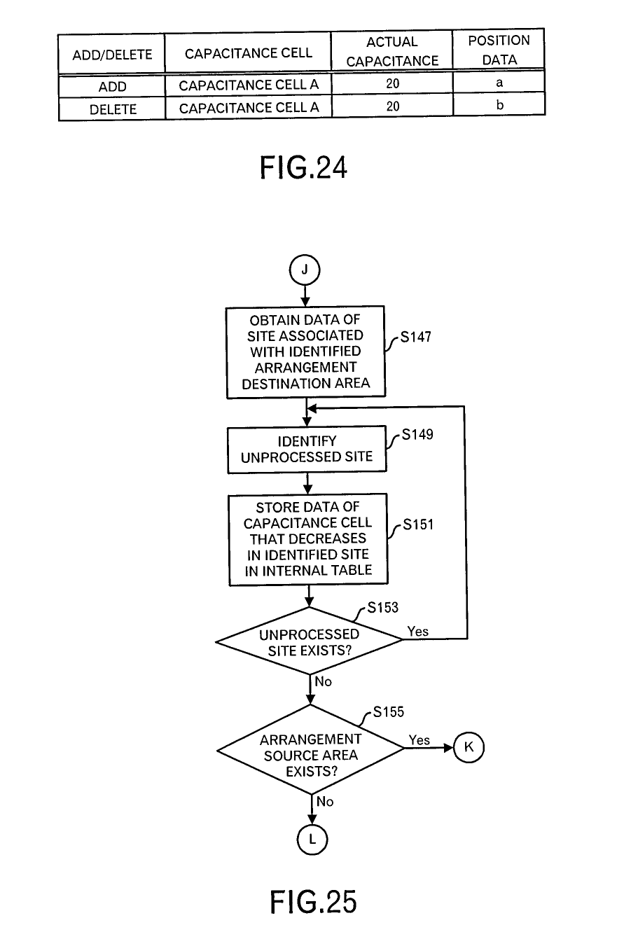

On the other hand, when there is an arrangement source area, the data output unit 112 obtains data of the site associated with the arrangement source area from DB 120, for example (step S141). When there is a case where plural sites are associated with the arrangement source area, data of all of the sites is obtained. Then, the data output unit 112 identifies one unprocessed site (step S142). After that, the data output unit 112 stores data of the capacitance cell that increases in the identified site into the internal table (step S143). In this embodiment, when the logic cell or the like is moved, the capacitance cell is automatically arranged in the vacant area that is generated in the site of the arrangement source. Therefore, the vacant area that is generated in the site of the arrangement source is identified, and the capacitance cell that is projected to be arranged in the vacant area is identified, and the capacitance cell that is projected to be arranged, the actual capacitance of the capacitance cell and data of the projected arrangement position are stored in the internal table. For example, as illustrated in FIG. 24, a flag representing whether this is the capacitance cell to be added or the capacitance cell to be deleted, an identifier of the capacitance cell, the actual capacitance and position data are registered.

Then, the data output unit 112 determines whether or not there is an unprocessed site (step S145). When there is an unprocessed site, the processing returns to the step S142. On the other hand, when there is no unprocessed site, the processing shifts to a processing of FIG. 25 through the terminal J.

Shifting to the explanation of the processing in FIG. 25, the data output unit 112 obtains data of the site associated with an arrangement destination area that is the capacitance check area including the projected arrangement position from the DB 120 (step S147). Because plural sites are associated with the arrangement destination area, data of all of the sites is obtained. Then, the data output unit 112 identifies one unprocessed site (step S149). After that, the data output unit 112 stores the data of the capacitance cell that is decreased in the identified site into the internal table (step S151). In this embodiment, it is assumed that the logic cell and the like cannot be arranged at the position where the cell other than the capacitance cell is arranged. Therefore, when the object to be arranged is arranged, the capacitance cell is deleted. Therefore, the capacitance cell that overlaps with the logic cell or the like is identified among the capacitance cells that have already been arranged at the projected arrangement position, and the capacitance cell to be deleted, the actual capacitance of that capacitance cell and data of the arrangement source position are stored in the internal table.

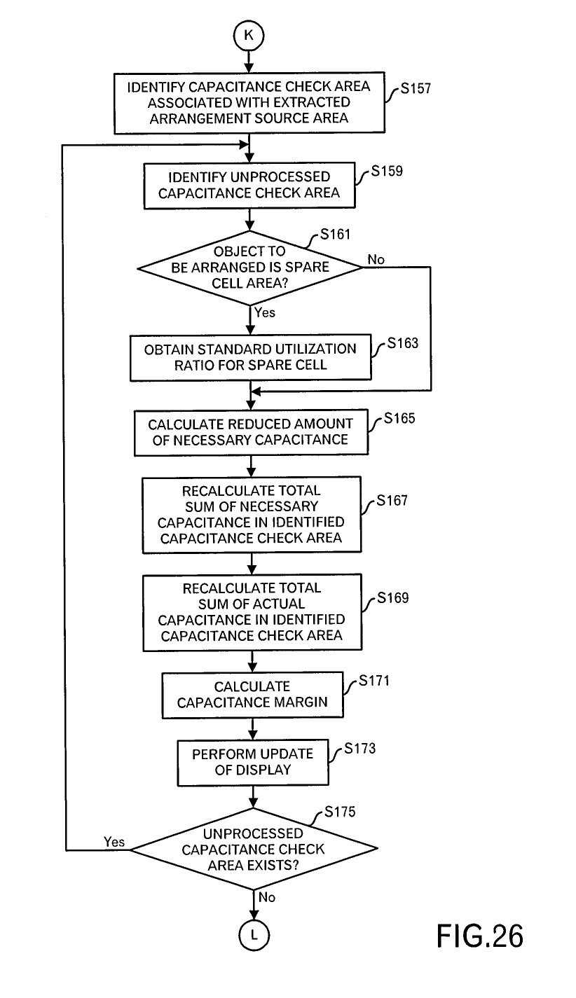

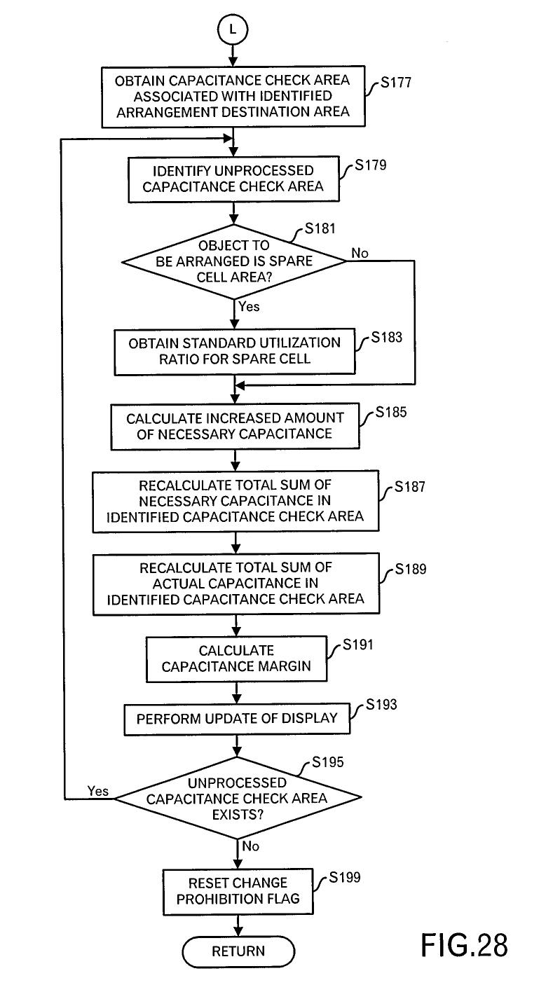

Then, the data output unit 112 determines whether or not there is an unprocessed site (step S153). When there is an unprocessed site, the processing returns to the step S149. On the other hand, when there is no unprocessed site, the data output unit 112 determines whether or not there is an arrangement source area (step S155). When there is no arrangement source area, the processing shifts to a processing of FIG. 28 through terminal L. On the other hand, when there is an arrangement source area, the processing shifts to a processing of FIG. 26 through terminal K.

Shifting to the explanation of the processing in FIG. 26, the data output unit 112 identifies the capacitance check area associated with the arrangement source area (step S157). As described above, there is a case where plural capacitance check areas are associated. Then, the margin calculation unit 1121 of the data output unit 112 identifies one unprocessed capacitance check area (step S159), and determines whether or not the object to be arranged is the spare cell area (step S161). When the object to be arranged is the spare cell area, the margin calculation unit 1121 obtains the standard utilization ratio of the spare cell, which is included in the parameters for the capacitance margin map (step S163). Then, the processing shifts to step S165. On the other hand, when the object to be arranged is not the spare cell area, the processing shifts to the step S165.

After that, the margin calculation unit 1121 calculates a reduced amount of necessary capacitance in the arrangement source area, and stores the calculated amount into the storage device such as the main memory (step S165). When the object to be arranged is the logic cell, the necessary capacitance of the logic cell is the reduced amount of necessary capacitance. On the other hand, when the object to be arranged is the spare cell area, the reduced amount of necessary capacitance is calculated by “the standard utilization ratio of the spare cell”*“the necessary capacitance of the spare cell area” by using the standard utilization ratio of the spare cell, which was obtained at the step S163.

Furthermore, the margin calculation unit 1121 recalculates the total sum of necessary capacitance in the identified capacitance check area, and stores the calculated value into the storage device such as the main memory (step S167). Because the total sum of necessary capacitance in the state where the arrangement is fixed is registered in the management table (FIG. 16), the total sum of necessary capacitance in case where the object to be arranged is preliminarily moved can be obtained by {“the total sum of necessary capacitance”−“the reduced amount of necessary capacitance”}.

Furthermore, the margin calculation unit 1121 recalculates the total sum of actual capacitance in the identified capacitance check area, and stores the calculated value into the storage device such as the main memory (step S169). Because the total sum of actual capacitance in the state where the arrangement is fixed is registered in the management table (FIG. 16), the total sum of actual capacitance in case where the object to be arranged is preliminarily moved is obtained by {“total sum of actual capacitance”+“actual capacitance of the capacitance cell to be added (actual capacitance of the capacitance cell, which is registered as “add” in the internal table)”}.

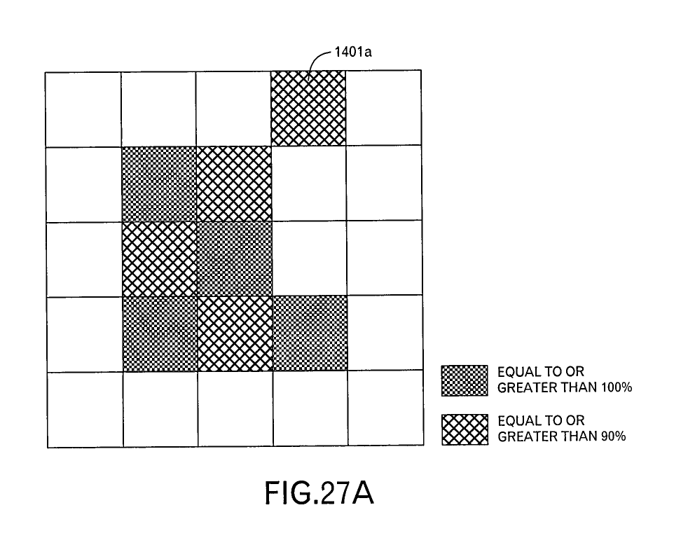

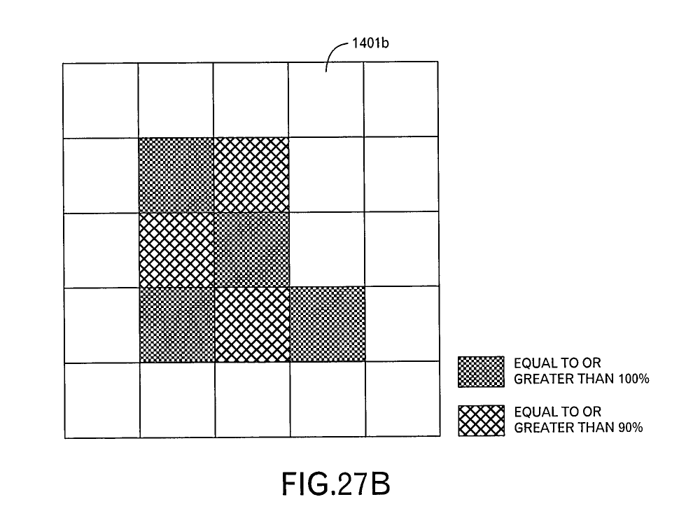

After that, the margin calculation unit 1121 calculates the capacitance margin by “the total sum of necessary capacitance”/“the total sum of actual capacitance”, and stores the calculated value into the storage device such as the main memory (step S171). Then, the data output unit 112 performs the update of the display based on the calculated capacitance margin (step S173). In the capacitance margin map as illustrated in FIG. 27A, when the logic cell included in the capacitance check area 1401a is moved to another place, the actual capacitance increases and the necessary capacitance decreases. Therefore, the capacitance margin was equal to or greater than 0.9 and less than 1.0, however, as illustrated in FIG. 27B, the capacitance margin becomes less than 0.9. Therefore, the coloring may not be performed like the capacitance check area 1401b, for example.

Then, the margin calculation unit 1121 determines whether or not there is an unprocessed capacitance check area (step S175). When there is an unprocessed capacitance check area, the processing returns to the step S159. On the other hand, when there is no unprocessed capacitance check area, the processing shifts to the processing in FIG. 28 through the terminal L.

Shifting to the explanation of the processing in FIG. 28, the data output unit 112 identifies a capacitance check area associated with the arrangement destination area (step S177). As described above, plural capacitance check areas may be associated. Then, the margin calculation unit 1121 of the data output unit 112 identifies one unprocessed capacitance check area (step S179), and determines whether or not the object to be arranged is the spare cell area (step S181). When the object to be arranged is the spare cell area, the margin calculation unit 1121 obtains the standard utilization ratio of the spare cell, which is included in the parameters for the capacitance margin map (step S183). Then, the processing shifts to the step S185. On the other hand, when the object to be arranged is not the spare cell area, the processing shifts to the step S185.

After that, the margin calculation unit 1121 calculates an increased amount of necessary capacitance in the arrangement destination area, and stores the calculated value into the storage device such as the main memory (step S185). When the object to be arranged is the logic cell, the necessary capacitance of the logic cell is the increased amount of necessary capacitance. On the other hand, when the object to be arranged is the spare cell area, the increased amount of necessary capacitance is calculated by {“the standard utilization ratio of the spare cell”*“the necessary capacitance of the spare cell area”} by using the standard utilization ratio of the spare cell, which was obtained at the step S183.

Furthermore, the margin calculation unit 1121 recalculates the total sum of necessary capacitance in the identified capacitance check area, and stores the calculated value into the storage device such as the main memory (step S187). Because the total sum of necessary capacitance in the state where the arrangement is f fixed is registered in the management table (FIG. 16), the total sum of necessary capacitance in case where the object to be arranged is preliminarily arranged is obtained by {“the total sum of necessary capacitance”+“the increased amount of necessary capacitance”}.

Furthermore, the margin calculation unit 1121 recalculates the total sum of actual capacitance in the identified capacitance check area, and stores the calculated value into the storage device such as the main memory (step S189). Because the total sum of actual capacitance in the state where the arrangement is fixed is registered in the management table (FIG. 16), the total sum of actual capacitance in case where the object to be arranged is preliminarily arranged is obtained by {“the total sum of actual capacitance”−“the actual capacitance of the capacitance cell to be deleted (the actual capacitance of the capacitance cell, which is registered as “delete” in the internal table)”}.

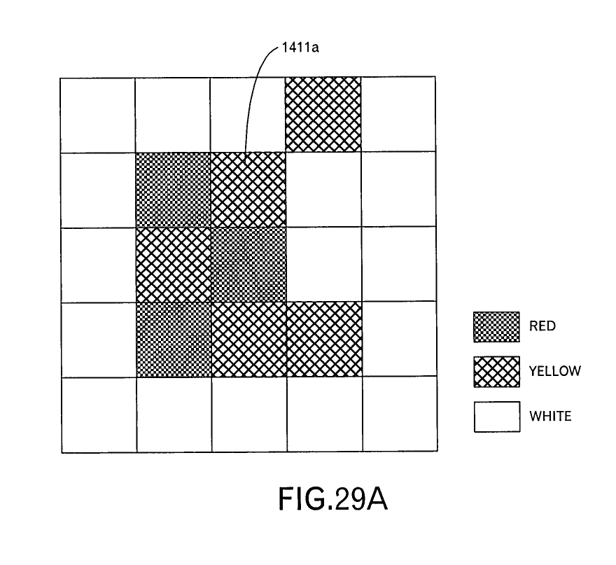

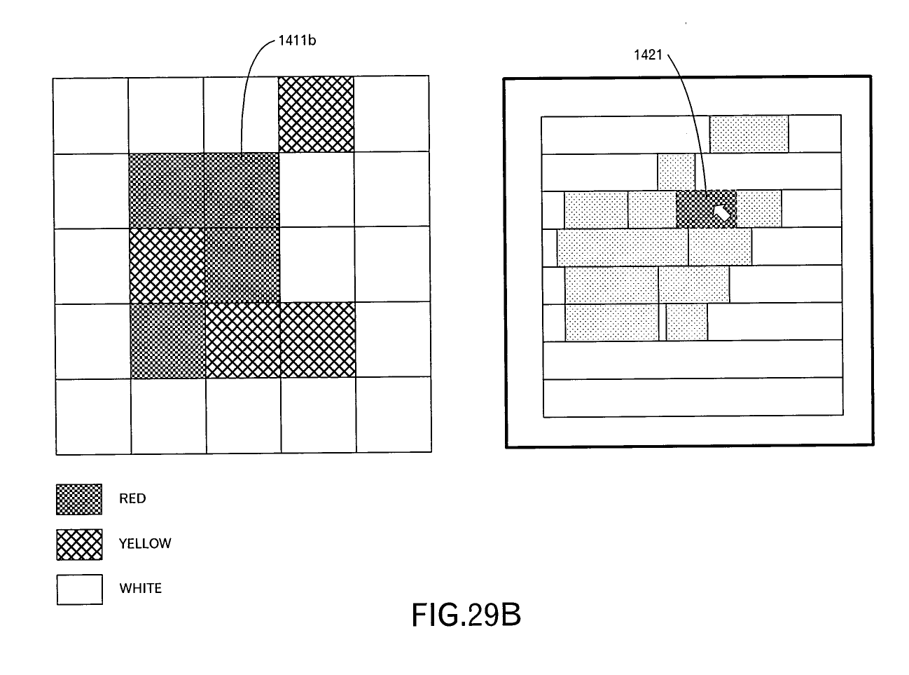

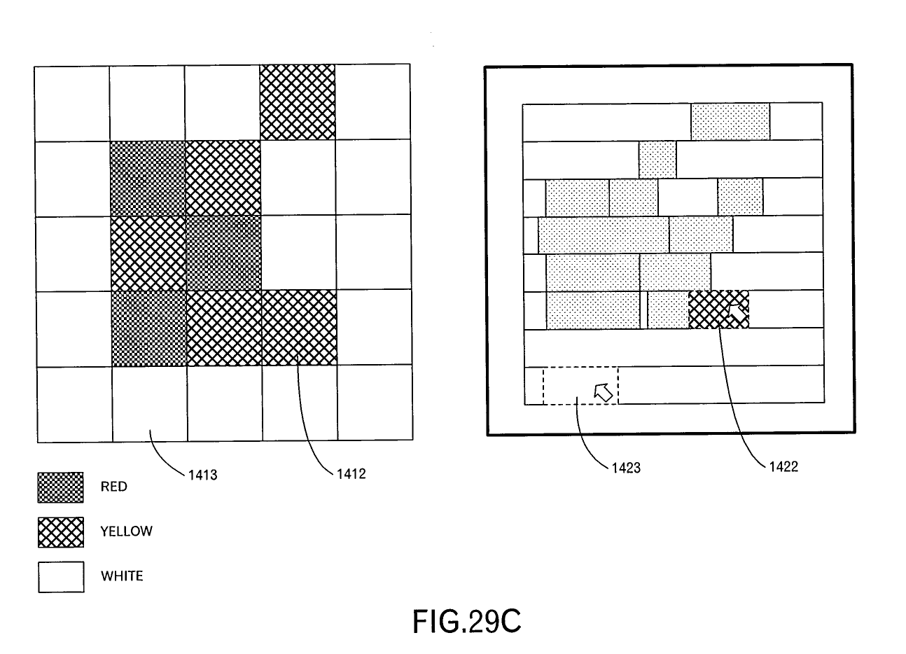

After that, the margin calculation unit 1121 calculates the capacitance margin by {“the total sum of necessary capacitance”/“the total sum of actual capacitance”}, and stores the calculated value into the storage device such as the main memory (step S191). Then, the data output unit 112 performs the update of the display based on the calculated capacitance margin (step S193). The capacitance margin map illustrated in FIG. 29A is displayed, and it is assumed that the color corresponding to the capacitance margin, which is equal to or greater than 0.9 and less than 1.0, is painted to the capacitance check area 1411a. Then, as illustrated in FIG. 29B, when, in the arrangement task window, the logic cell is dragged to the projected arrangement position 1421 for example, the aforementioned calculation is performed. Then, because the capacitance margin of the capacitance check area 1411a exceeds 1.0, as illustrated in FIG. 29B, the color corresponding to the capacitance margin, which is equal to or greater than 1.0, is painted to the capacitance check area 1411b, and the color of the logic cell is changed to the same color.

Similarly, as illustrated in FIG. 29C, for example, even when the logic cell is dragged to the projected arrangement position 1422 in the arrangement task window, and the aforementioned calculation is performed, the range to which the calculated capacitance margin belongs does not change. Then, the color of the capacitance check area 1412 in the capacitance margin map does not change, and the same color is also displayed for the logic cell. Furthermore, even when the logic cell is dragged to the projected arrangement position 1423 and the aforementioned calculation is performed, it is assumed that the range to which the calculated capacitance margin belongs does not change. Then, the color for the capacitance check area 1413 does not change even in the capacitance margin map, and the same color is also displayed in the logic cell.

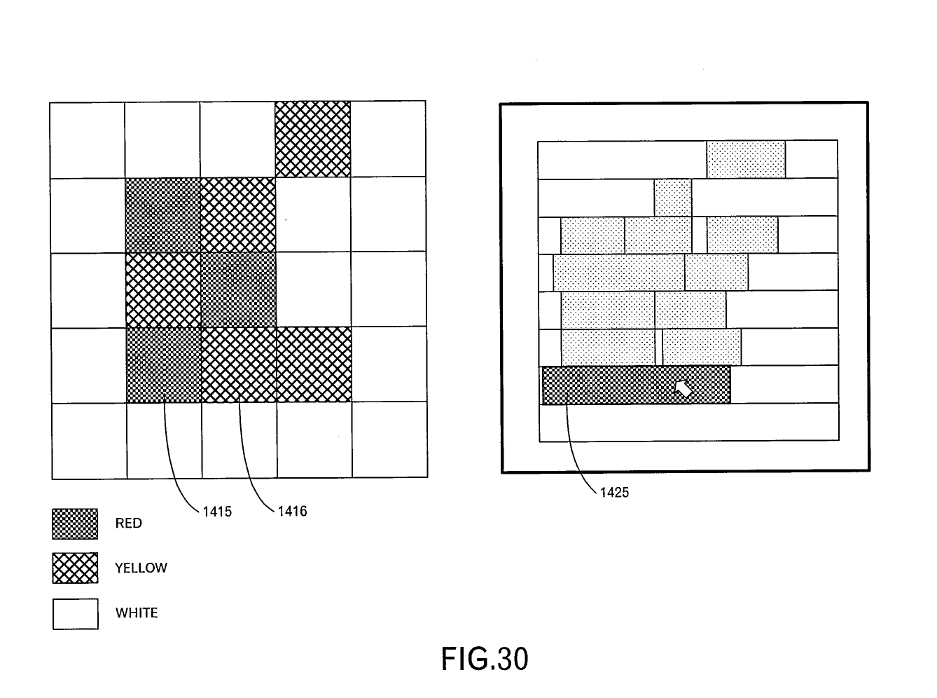

The case where the spare cell area is arranged instead of the logic cell is similar. As illustrated in FIG. 30, when the spare cell area is arranged to the projected arrangement position 1425 in the arrangement task window, the capacitance check areas 1415 and 1416, which include the projected arrangement position 1425, are identified. In such a case, as for the capacitance check area 1415, the capacitance margin becomes equal to or greater than 1.0, however, as for the capacitance check area 1416, the capacitance margin becomes equal to or greater than 0.9 and less than 1.0, and it is assumed that the range to which the capacitance margin belongs does not change even when the spare cell area is arranged. Then, the spare cell area, which was dragged to the projected arrangement position 1425, maybe painted for each corresponding capacitance check area, however, for example, the coloring may be performed based on the value, which is higher among the capacitance margins. In FIG. 30, the latter method is employed.

Then, the margin calculation unit 1121 determines whether or not there is an unprocessed capacitance check area (step S195). When there is an unprocessed capacitance check area, the processing returns to the step S179. On the other hand, when there is no unprocessed capacitance check area, the data output unit 112 resets the change prohibition flag for the parameters for the capacitance margin map (step S199). Then, the processing returns to the calling-source processing. The internal table is held in the storage device such as the main memory in order to use it in case where an instruction to fix the arrangement (e.g. instruction of the drop or the like). In other words, at the step S17, not only the arrangement of the object to be arranged, but also the arrangement change based on the data stored in the internal table are reflected to the DB 120.

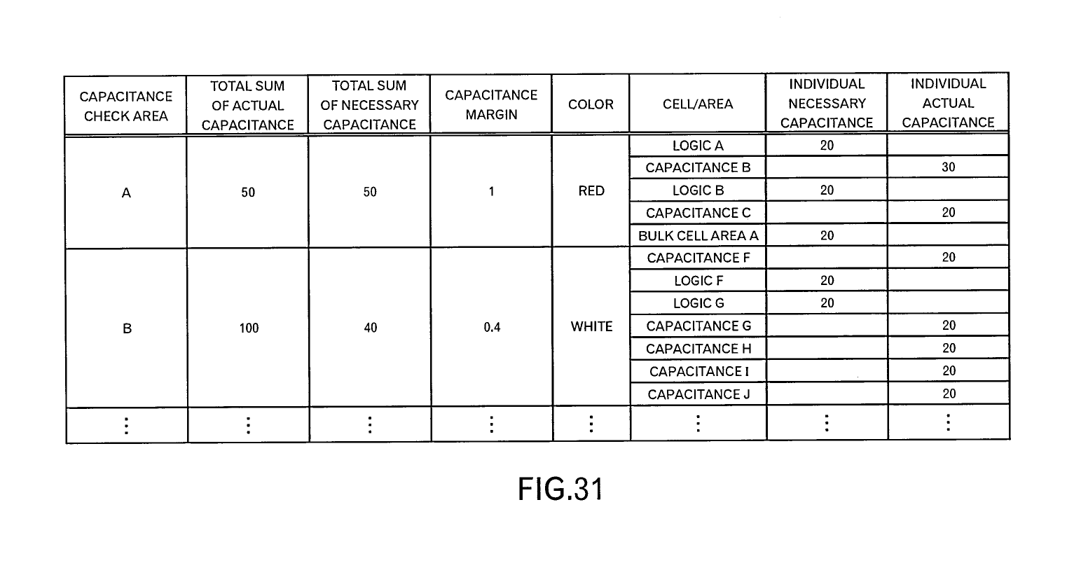

Moreover, at the step S17, the management table is also updated. For example, as illustrated in FIG. 31, in each capacitance check area, as for the total sum of actual capacitance, the total sum of necessary capacitance, the capacitance margin and the color in the capacitance margin map, data in the fixed state is reflected. The values obtained by the update processing, which were performed immediately before this timing, are reflected. Moreover, the individual necessary capacitance and individual actual capacitance for each cell or area, which belongs to each capacitance check area, are updated according to the arrangement information of the object to be arranged and information of the arrangement change based on the data stored in the internal table.

Thus, it is possible for the designer to search for the projected arrangement position at which the logic cell or the like is arranged in the capacitance margin map, and then to confirm how the capacitance margin changes in case where the object to be arranged is preliminary arranged at the projected arrangement position before the actual arrangement. In other words, the logic cell or the like is not fixedly arranged at the projected arrangement position, which may cause the problem, and the wasteful task and processing are reduced, and the efficient task and processing can be performed.

Although the embodiment of this technique was explained, this technique is not limited to this embodiment. For example, as for the processing flow, as long as the processing results are not changed, the turns of the processing steps may be exchanged, and plural processing steps may be executed in parallel.

Furthermore, the aforementioned functional block configuration is a mere example, and does not always correspond to an actual program module configuration.

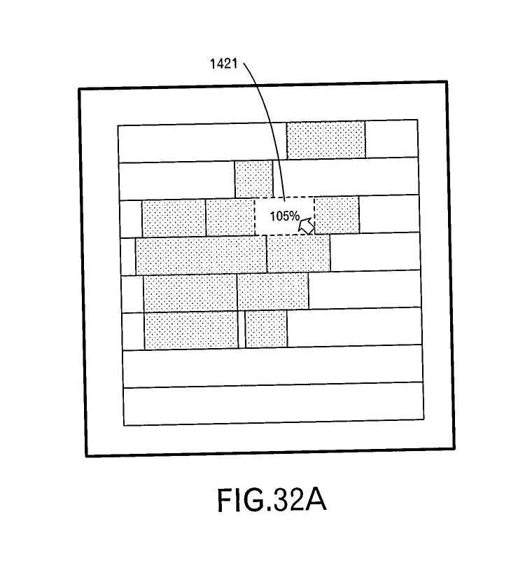

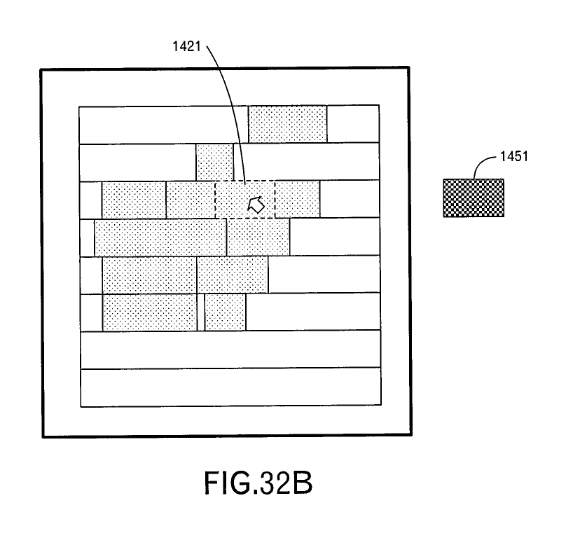

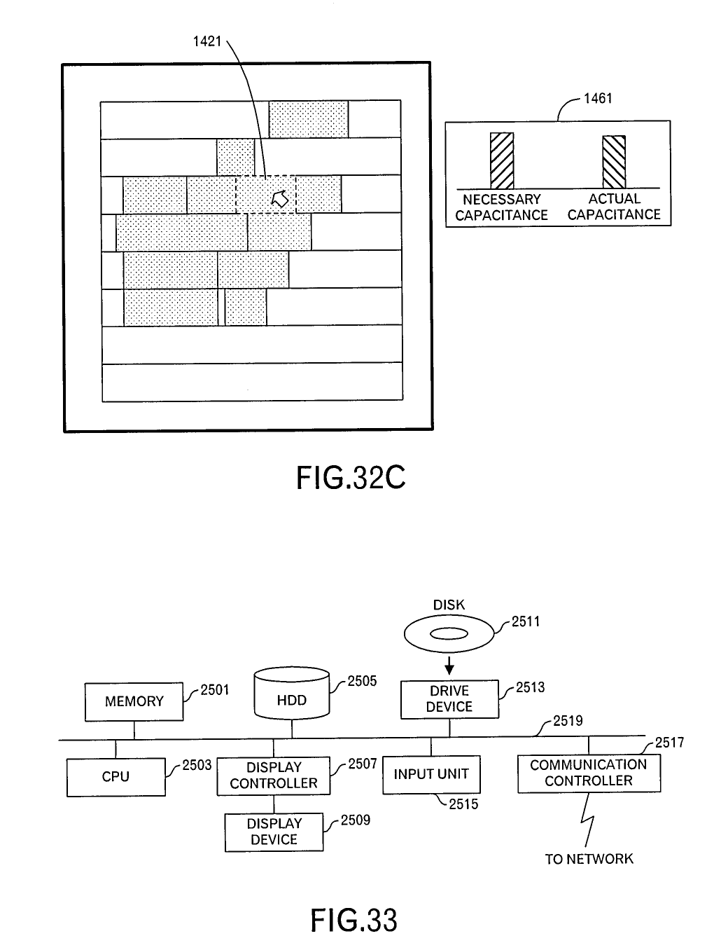

Moreover, the display method can be variously changed. For example, although the example was depicted in which the capacitance margin is represented by the numerical value or color, it is possible to represent the capacitance margins by changing the modes of the hatching. Furthermore, although the example was depicted in which the color of the object to be arranged is changed in the arrangement task window, the numerical value instead of the color may be depicted within the object to be arranged as illustrated in FIG. 32A. Furthermore, as illustrated in FIG. 32B, the numerical value or color may be presented in the display column 1451 outside the object to be arranged.

Furthermore, instead of the capacitance margin, the total sum of necessary capacitance and the total sum of actual capacitance may be presented in a comparable manner. For example, as illustrated in FIG. 32C, the necessary capacitance and actual capacitance may be displayed in the display column 1461. Moreover, the numerical value may be displayed in the display column 1461 or other expression methods such as a pie chart may be employed.

Moreover, the capacitance margin map and the arrangement task window are displayed beside each other, and a processing was explained, which is to update the logic cell or the like, which will be arranged in the arrangement task window, and the corresponding capacitance check area in the capacitance margin map with the same color. However, the result of the fixed arrangement may be reflected to the capacitance margin map, and as for the logic cell or the like, which will be arranged in the arrangement task window, the color in case where it is preliminarily arranged may be displayed. Thus, it is possible to compare the states before and after the arrangement.

Furthermore, after temporarily performing the capacitance check by other methods, the correction may be performed by this editor 110. Also at that time, the processing subsequent to the update processing may be sufficient.

In addition, the aforementioned design support apparatus 100 is a computer device as illustrated in FIG. 33. That is, a memory 2501 (storage device), a CPU 2503 (processor), a hard disk drive (HDD) 2505, a display controller 2507 connected to a display device 2509, a drive device 2513 for a removable disk 2511, an input unit 2515, and a communication controller 2517 for connection with a network are connected through a bus 2519 as illustrated in FIG. 33. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the application programs systematically cooperate with each other, so that various functions as described above in details are realized.

The aforementioned embodiments are outlined as follows:

A design support apparatus relating to this embodiment includes (A) an arrangement unit to arrange a capacitance cell in a vacant area in a cell arrangement area of a semiconductor integrated circuit; (B) a data storage unit that stores capacitance of a capacitance cell and necessary capacitance of a logic cell; and (C) an information output unit that is configured to: (c1) upon detecting that a position at which a certain logic cell will be arranged is designated, calculate, by using data stored in the data storage unit, a total sum of capacitance for a first capacitance check area that includes the position among plural capacitance check areas that are included in the cell arrangement area, while assuming that a capacitance cell at the position is removed; (c2) upon detecting that the position is designated, calculate, by using data stored in the data storage unit, a total sum of necessary capacitance for the first capacitance check area, while assuming that the certain logic cell is arranged at the position; and (c3) output information that represents a relationship between the total sum of capacitance and the total sum of necessary capacitance for the first capacitance check area.

Thus, it is possible to determine whether or not a problem will occur in view of the capacitance before actually arranging. In other words, when the logic cell is arranged at a place in which there is no problem, it is possible to perform a task and processing efficiently without any rework.

Moreover, the aforementioned information output unit may be further configured to calculate , for each capacitance check area of the plural capacitance check areas, a second total sum of capacitance and a second total sum of necessary capacitance, which are caused by cells that have already been arranged in the capacitance check area; and output, for each capacitance check area of the plural capacitance check areas, second information that represents a relationship between the second total sum of capacitance and the second total sum of necessary capacitance. Thus, it becomes possible to determine the projected arrangement position of the logic cell while considering the current situation.

Furthermore, the aforementioned data storage unit may further store necessary capacitance of a spare cell area. In such a case, the aforementioned information output unit may be further configured to: upon detecting that a second position at which a certain spare cell area will be arranged is designated, calculate, by using data stored in the data storage unit, a second total sum of capacitance for a second capacitance check area that includes the second position, while assuming that a capacitance cell at the second position is removed; calculate a second total sum of necessary capacitance for the second capacitance check area, by using a ratio of an area that will be used as a logic cell to an area of a spare cell area and data stored in the data storage unit, while assuming that the certain spare cell area is arranged at the second position; and output second information that represents a relationship between the second total sum of capacitance and the second total sum of necessary capacitance for the second capacitance check area. Thus, as for the spare cell area, while considering the aforementioned ratio, it is possible to determine whether or not the projected arrangement position is appropriate, in view of the capacitance in case where the spare cell area is arranged at the projected arrangement position. Furthermore, even when the spare cell area is actually used as the logic cell, the problem hardly occurs in view of the capacitance.

Moreover, the aforementioned information output unit may be further configured to: upon detecting that the certain logic cell has already been arranged at another position and will be moved, calculate, by using data stored in the data storage unit, a second total sum of capacitance for a second capacitance check area that includes the another position, while assuming that a corresponding capacitance cell is arranged at the another position; calculate, by using data stored in the data storage unit, a second total sum of necessary capacitance for the second capacitance check area, while assuming that the certain logic cell is removed; and output second information that represents a relationship between the second total sum of capacitance and the second total sum of necessary capacitance for the second capacitance check area. It is possible to cope with not only a case where a logic cell is newly arranged, but also a case where the logic cell is moved. Especially, because the capacitance cell is automatically arranged at an arrangement source position, it is possible to accurately calculate the total sum of capacitance and the total sum of necessary capacitance for the capacitance check area including the arrangement source position.

Furthermore, the aforementioned information output unit may further be configured to: upon detecting that the certain spare cell area has already been arranged at another second position and will be moved, calculate, by using data stored in the data storage unit, a third total sum of capacitance for a third capacitance check area that includes the another second position, while assuming that a corresponding capacitance cell is arranged at the another second position; calculate a third total sum of necessary capacitance for the third capacitance check area, by using the ratio and data stored in the data storage unit, while assuming that the certain spare cell area is removed; and output third information that represents a relationship between the third total sum of capacitance and the third total sum of necessary capacitance for the third capacitance check area. It is possible to move the spare cell area similarly to the logic cell.

Moreover, the aforementioned information may be a ratio of the total sum of necessary capacitance to the total sum of capacitance or data of a display mode corresponding to the ratio. Various display modes may be employed, however, when the aforementioned ratio is employed, it is easy to understand the situation.

The aforementioned data storage unit may further store, for each capacitance check area of the plural capacitance check areas, a total sum of capacitance and a total sum of necessary capacitance for cells that have already been arranged in the capacitance check area. Thus, it is possible to rapidly calculate the total sum of capacitance and the total sum of necessary capacitance. For example, when the logic cell is arranged, it is possible to calculate the new total sum of capacitance by reducing the capacitance of the capacitance cell to be removed from the total sum of capacitance and calculate the new total sum of necessary capacitance by adding the necessary capacitance of the logic cell to the total sum of necessary capacitance.

The aforementioned arrangement unit may operate prior to the information output unit. For example, by operating the arrangement unit firstly, it is possible to accurately calculate the total sum.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk.

In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A design support apparatus, comprising:
a memory; and
a processor configured to use the memory and execute a process, comprising:
arranging capacitance cells in an entire area of a cell arrangement area of a semiconductor integrated circuit, before arranging logic cells;
upon detecting that a position at which a certain logic cell will be arranged is designated, first calculating a total sum of capacitance for a first capacitance check area that includes the position among a plurality of capacitance check areas that are included in the cell arrangement area, while assuming that a capacitance cell at the position is removed;
upon detecting that the position is designated, second calculating a total sum of necessary capacitance for the first capacitance check area, while assuming that the certain logic cell is arranged at the position; and
outputting information that represents a relationship between the total sum of capacitance and the total sum of necessary capacitance for the first capacitance check area.

2. The design support apparatus as set forth in claim 1, wherein the process further comprises:
calculating, for each capacitance check area of the plurality of capacitance check areas, a second total sum of capacitance and a second total sum of necessary capacitance, which are caused by cells that have already been arranged in the capacitance check area; and
outputting, for each capacitance check area of the plurality of capacitance check areas, second information that represents a relationship between the second total sum of capacitance and the second total sum of necessary capacitance.

3. The design support apparatus as set forth in claim 1, wherein the process further comprises:
upon detecting that a second position at which a certain spare cell area will be arranged is designated, calculating a second total sum of capacitance for a second capacitance check area that includes the second position, while assuming that a capacitance cell at the second position is removed;
calculating a second total sum of necessary capacitance for the second capacitance check area, by using a ratio of an area that will be used as a logic cell to an area of a spare cell area, while assuming that the certain spare cell area is arranged at the second position; and
outputting second information that represents a relationship between the second total sum of capacitance and the second total sum of necessary capacitance for the second capacitance check area.

4. The design support apparatus as set forth in claim 1, wherein the process further comprises:
upon detecting that the certain logic cell has already been arranged at another position and will be moved, calculating a second total sum of capacitance for a second capacitance check area that includes the another position, while assuming that a corresponding capacitance cell is arranged at the another position;
calculating a second total sum of necessary capacitance for the second capacitance check area, while assuming that the certain logic cell is removed; and
outputting second information that represents a relationship between the second total sum of capacitance and the second total sum of necessary capacitance for the second capacitance check area.

5. The design support apparatus as set forth in claim 3, wherein the process further comprises:
upon detecting that the certain spare cell area has already been arranged at another second position and will be moved, calculating a third total sum of capacitance for a third capacitance check area that includes the another second position, while assuming that a corresponding capacitance cell is arranged at the another second position;
calculating a third total sum of necessary capacitance for the third capacitance check area, by using the ratio, while assuming that the certain spare cell area is removed; and
outputting third information that represents a relationship between the third total sum of capacitance and the third total sum of necessary capacitance for the third capacitance check area.

6. The design support apparatus as set forth in claim 1, wherein the information is a ratio of the total sum of necessary capacitance to the total sum of capacitance or data of a display mode corresponding to the ratio.

7. The design support apparatus as set forth in claim 1, wherein, in the first calculating and the second calculating, a total sum of capacitance and a total sum of necessary capacitance for cells that have already been arranged in the first capacitance check area, which are stored in a data storage unit in advance, is used.

8. A design support method, comprising:
arranging, by using a computer, capacitance cells in an entire area of a cell arrangement area of a semiconductor integrated circuit , before arranging logic cells;
upon detecting that a position at which a certain logic cell will be arranged is designated, first calculating, by using the computer, a total sum of capacitance for a first capacitance check area that includes the position among a plurality of capacitance check areas that are included in the cell arrangement area, while assuming that a capacitance cell at the position is removed;
upon detecting that the position is designated, second calculating, by using the computer, a total sum of necessary capacitance for the first capacitance check area, while assuming that the certain logic cell is arranged at the position; and
outputting, by using the computer, information that represents a relationship between the total sum of capacitance and the total sum of necessary capacitance for the first capacitance check area.

9. A non-transitory computer-readable storage medium storing a program for causing a computer to execute a process, comprising:
arranging capacitance cells in in an entire area of a cell arrangement area of a semiconductor integrated circuit, before arranging logic cells;
upon detecting that a position at which a certain logic cell will be arranged is designated, first calculating a total sum of capacitance for a first capacitance check area that includes the position among a plurality of capacitance check areas that are included in the cell arrangement area, while assuming that a capacitance cell at the position is removed;
upon detecting that the position is designated, second calculating a total sum of necessary capacitance for the first capacitance check area, while assuming that the certain logic cell is arranged at the position; and
outputting information that represents a relationship between the total sum of capacitance and the total sum of necessary capacitance for the first capacitance check area.
